(19) United States
(12) Patent Application Publication
(10) Pub. No.: US 2025/0074107 A1
(43) Pub. Date: Mar. 6, 2025

(54) MULTIPLE COMPOSITE BICYCLE RIM

(71) Applicant: SRAM, LLC, CHICAGO, IL (US)

(72) Inventors: RUAN TROUW, MOORESVILLE, IN (US); DAVID MORSE, INDIANAPOLIS, IN (US); BRIAN JORDAN, CHICAGO, IL (US)

(73) Assignee: SRAM, LLC, CHICAGO, IL (US)

(21) Appl. No.: 18/457,144

(22) Filed: Aug. 28, 2023

(51) Int. Cl. B60B 5/02; B29C 70/22; B29C 70/34; B60B 1/00

(52) U.S. Cl. CPC B60B 5/02; B29C 70/222; B29C 70/34; B60B 1/003; B29K 2307/04; B29K 2311/10; B29L 2031/32; B60B 2310/204; B60B 2360/3416

(57) ABSTRACT

A rim for a bicycle wheel includes a radially inner portion disposed along an inner circumference of the rim, a first sidewall, a second sidewall spaced apart from the first sidewall, a radially outer tire engaging portion disposed along an outer circumference of the rim, and an opening. The first sidewall, the second sidewall, the radially outer tire engaging portion, the radially inner portion, or any combination thereof includes a composite laminate. The composite laminate includes one or more compressed layers of a first composite material, which includes a matrix of a polymer-based material and natural fibers for a reinforcing material, and one or more compressed layers of a second composite material that is different than the first composite material. The opening extends through at least one layer of the one or more compressed layers of the second composite material, such that the second composite material surrounds the opening.

### BACKGROUND

### 1. Field of the Disclosure

The present disclosure is generally directed to a composite bicycle rim, and more particularly, to a bicycle rim made of multiple composites, including a natural fiber composite.

### 2. Description of Related Art

A traditional bicycle wheel may include a rim formed of extruded metals or other materials that are bent and bonded into a circular shape having consistently shaped cross sections. Recently, other materials, such as fiber reinforced plastics, have been used in the manufacture of bicycle rims, which may be formed into circular shapes through non-extrusion based processes. Carbon fiber reinforced plastics may, for example, be used.

A method for manufacturing a fiber-based bicycle wheel relies on the stacking of individual sheets of fiber composite material to form structures such as a side wall of the rim. The fiber sheets may be pre-impregnated with a resin or other matrix material that undergoes a curing process to form the rim.

Openings may be formed through the structures of the rim. For example, holes may be drilled through a radially inner portion of the rim to form spoke holes. Spoke holes are adjacent to heavily prestressed areas of the rim. Therefore, any degradation in strength at the spoke holes due to moisture may lead to failures.

### SUMMARY

In one example, a rim for a bicycle wheel includes a radially inner portion disposed along an inner circumference of the rim, a first sidewall, and a second sidewall spaced apart from the first sidewall. The first sidewall and the second sidewall extend radially outward from the radially inner portion. The rim also includes a radially outer tire engaging portion disposed along an outer circumference of the rim. The radially outer tire engaging portion extends from the first sidewall and the second sidewall, respectively, and an opening that extends through the radially inner portion, the first sidewall, the second sidewall, the radially outer tire engaging portion, or any combination thereof. The first sidewall, the second sidewall, the radially outer tire engaging portion, the radially inner portion, or any combination thereof includes a composite laminate. The composite laminate includes one or more compressed layers of a first composite material and one or more compressed layers of a second composite material. The second composite material is different than the first composite material and has a lower porosity compared to the first composite material. The first composite material includes a matrix of a polymer-based material and natural fibers for a reinforcing material. The opening extends through at least one layer of the one or more compressed layers of the second composite material, such that the second composite material surrounds the opening.

In one example, the polymer-based material is a thermoplastic, a thermoset matrix, or a combination thereof. The natural fibers of the reinforcing material are flax fibers.

In one example, the polymer-based material is a first polymer-based material, and the reinforcing material is a first reinforcing material. The second composite material includes a matrix of a second polymer-based material and fibers for a second reinforcing material. The second polymer-based material is a plastic, an acrylic, a resin, an epoxy, or any combination thereof. The fibers of the second reinforcing material are carbon fibers.

In one example, the opening is a first opening that extends through the radially inner portion. The rim further includes a second opening that extends through the radially outer tire engaging portion. The at least one layer of the second composite material is at least one first layer of the second composite material. The second opening extends through at least one second layer of the one or more compressed layers of the second composite material, such that the second composite material surrounds the second opening.

In one example, the first opening is a spoke hole, a valve hole, or an opening in which an electronic component of the bicycle is supportable. The second opening is an access hole.

In one example, the at least one first layer of the second composite material forms at least part of the radially inner portion, the part of the radially inner portion extending all of the way around the radially inner portion.

In one example, the at least one second layer of the second composite material forms at least part of the radially outer tire engaging portion, the part of the radially outer tire engaging portion extending all of the way around the radially outer tire engaging portion.

In one example, the opening is a first opening that extends through the radially inner portion. The rim further includes a second opening that extends through the radially inner portion. The second opening is at a distance away from first opening along the radially inner portion.

In one example, the at least one layer of the second composite material is at least one first layer of the second composite material. The second opening extends through at least one second layer of the one or more compressed layers of the second composite material, such that the second composite material surrounds the second opening.

In one example, at least one layer of the one or more compressed layers of the first composite material partially forms the radially inner portion. The at least one layer of the first composite material is disposed between the at least one first layer of the second composite material and the at least one second layer of the second composite material.

In one example, the first opening and the second opening are spoke holes, respectively.

In one example, a method of manufacturing a bicycle component includes positioning a layer of a first composite material within a mold. The first composite material includes natural fibers of a first reinforcing material. The method includes positioning a layer of a second composite material within the mold, such that a portion of the layer of the second composite material abuts, overlaps, or abuts and overlaps the layer of the first composite material. The second composite material includes fibers of a second reinforcing material. The second reinforcing material is different than the first reinforcing material. The method includes forming the bicycle component. Forming the bicycle component includes forming a composite laminate that includes the layer of the first composite material and the layer of the second composite material within the mold. The method includes forming an opening through the layer of the second composite material of the composite laminate, such that the second composite material surrounds the opening.

In one example, the natural fibers of the first reinforcing material are flax fibers. The fibers of the second reinforcing material are carbon fibers.

In one example, forming the opening through the layer of the second composite material of the composite laminate includes drilling the opening through the layer of the second composite material of the composite laminate.

In one example, the layer of the first composite material and the layer of the second composite material form portions of a radially inner portion of the rim or a radially outer tire engaging portion of the rim, respectively.

In one example, the layer of the second composite material is a first layer of the second composite material, and the opening is a first opening. The method further includes positioning a second layer of the second composite material within the mold, such that a portion of the second layer of the second composite material abuts, overlaps, or abuts and overlaps the layer of the first composite material and the layer of the first composite material is between the first layer of the second composite material and the second layer of the second composite material. The method further includes forming a second opening through the composite laminate. The forming of the second opening includes forming the second opening through the second layer of the second composite material of the composite laminate, such that the second composite material surrounds the second opening.

In one example, the bicycle component is a rim. The layer of the second composite material extends all of the way around the rim and forms at least part of a radially inner portion disposed along an inner circumference of the rim, or at least part of a radially outer tire engaging portion disposed along an outer circumference of the rim.

In one example, the layer of the second composite material is a first layer of the second composite material and forms at least part of the radially inner portion of the rim. The method further includes positioning a second layer of the second composite material within the mold, such that the layer of the first composite material is between the first layer of the second composite material and the second layer of the second composite material. The second layer of the second composite material forms at least part of the radially outer tire engaging portion.

In one example, the layer of the first composite material forms at least part of a sidewall of the rim.

In one example, a rim for a bicycle wheel includes a radially inner portion disposed along an inner circumference of the rim, a first sidewall, and a second sidewall spaced apart from the first sidewall. The first sidewall and the second sidewall extend radially outward from the radially inner portion. The rim includes a radially outer tire engaging portion disposed along an outer circumference of the rim. The radially outer tire engaging portion extends from the first sidewall and the second sidewall, respectively. The rim includes a number of openings that extend through the radially inner portion. The number of openings are spoke holes and are spaced apart from each other around the radially inner portion. At least the radially inner portion includes a composite laminate. The composite laminate includes one or more compressed layers of a first composite material and one or more compressed layers of a second composite material. The second composite material is different than the first composite material and has a lower porosity compared to the first composite material. The compressed layers of the first composite material and the second composite material each consist of plies of strips of corresponding composite material. The first composite material includes a matrix of a polymer-based material and natural fibers for a reinforcing material. The number of openings extend through at least one layer of the one or more compressed layers of the second composite material, such that the second composite material surrounds the number of openings.

In one example, the plies of strips of the first composite material overlap with the plies of strips of the second composite material.

In one example, the plies of strips of the first composite material interleave with the plies of strips of the second composite material.

### BRIEF DESCRIPTION OF THE DRAWINGS

Objects, features, and advantages of the present invention will become apparent upon reading the following description in conjunction with the drawing figures, in which:

FIG. 1 is a side view schematic of a bicycle that may be constructed to utilize a composite rim;

FIG. 2 is a side view of a wheel for a bicycle, such as the bicycle of FIG. 1;

FIG. 3 is a first perspective view of a first embodiment of a composite rim formed by layers of multiple composite materials;

FIG. 4 is a second perspective view of the composite rim of FIG. 3;

FIG. 5 is a side view of the composite rim of FIG. 3;

FIG. 6 is a first cross-section of the composite rim of FIG. 5, taken along axis 6-6;

FIG. 7 is a second cross-section of the composite rim of FIG. 5, taken along axis 7-7;

FIG. 8 is a top view of a first type of strip that may be used in a layup for the composite rim of FIG. 3;

FIG. 9 is a top view of a second type of strip that may be used in a layup for the composite rim of FIG. 3;

FIG. 10 is a first perspective view of a second embodiment of a composite rim formed by layers of multiple composite materials;

FIG. 11 is a second perspective view of the composite rim of FIG. 10;

FIG. 12 is a side view of the composite rim of FIG. 10;

FIG. 13 is a first cross-section of the composite rim of FIG. 12, taken along axis 13-13;

FIG. 14 is a second cross-section of the composite rim of FIG. 12, taken along axis 14-14;

FIG. 15 is a perspective view of a third embodiment of a composite rim formed by layers of multiple composite materials;

FIG. 16 is a flow chart of an embodiment of a method for manufacturing a rim;

FIG. 17 is an embodiment of a cross-section of the composite rim of FIG. 5, taken along axis 6-6;

FIG. 18 is an embodiment of a cross-section of the composite rim of FIG. 5, taken along axis 7-7;

FIG. 19 is an alternate embodiment of a cross-section of the composite rim of FIG. 5, taken along the axis 6-6;

FIG. 20 is an alternate embodiment of a cross-section of the composite rim of FIG. 5, taken along the axis 7-7;

FIG. 21 shows an overlapping configuration used in the rim of FIG. 5; and

FIG. 22 shows an interleaving configuration used in the rim of FIG. 5.

### DETAILED DESCRIPTION OF THE DISCLOSURE

The use of sheets or strips of carbon fiber, for example, to manufacture a composite rim of the prior art provides a number of advantages compared to traditional bicycle rims formed of extruded metals or other materials. For example, carbon fiber based bicycle rims have a high tensile strength, a low weight, and a low thermal expansion compared to traditional bicycle rims.

Carbon fiber composite bicycle parts, however, have a high specific stiffness, which is unfavorable for a rider of a bicycle in certain applications. This may result in undesirable locomotive energy losses due to vibrations transmitted from road asperities through components of the bicycle, to the rider. This may lead to physiological fatigue and compensation by the rider. Carbon is also an electrical conductor that may shield wireless signals used by electronic components of the bicycle. Carbon fibers may thus act as a Faraday cage that blocks wireless signals.

The present disclosure provides examples of bicycle parts, such as rims and wheels, made of thin ply low density cellulose composites (e.g., flax composites) that solve or improve upon one or more of the above-noted and/or other disadvantages with bicycle parts made entirely of carbon fiber composite or other non-traditional materials. The disclosed rims, for example, made at least partially of flax composites provide superior vibration damping, sound attenuation, and more ductile failures, while keeping a unique balance between stiffness, weight, and processability. The disclosed rims, for example, may also be, at least in part, non-electrically conductive, allowing wireless signals to pass through. The ability to be processed like carbon fiber composites provides that the cellulose fiber composite (e.g., flax composite) may also be used in a hybrid layup with carbon and/or other engineered fibers.

Rims and wheels made of flax composites may, however, perform poorly in wet and damp conditions. Most of a flax composite wheel, for example, can be sealed using paint, extra resin films, or barrier plies on a surface. Holes cut or drilled through the rim (e.g., the laminate) to form spoke and access holes, for example, expose fibers to the elements and, due to wear, may be difficult to keep sealed. Spoke holes are also adjacent to some of the most heavily prestressed areas of the rim. Therefore, any degradation in strength at the spoke holes due to moisture may lead to failures.

Moisture degradation at drilled holes in the rim, for example, may be reduced or prevented (e.g., the drilled holes may remain sealed) with the use of inherently solid and non-moisture wicking material at the drilled holes. For example, a fully sealed rim may be provided with a laminate in which natural fibers (e.g., flax fibers) are used in easily sealed locations, and other materials (e.g., materials that do not wick or absorb water or moisture, such as carbon fiber and/or fiberglass) are used in locations where sealing is difficult. The locations where sealing is difficult may include, for example, spoke holes, access holes, valve holes, and other holes/openings that support sensors and electronics.

As an example, for a wheel with spokes or nipples that extend through holes in a laminate forming an innermost surface of a rim (e.g., a radially inner portion of the rim), the laminate may include carbon or fiberglass, for example, around the holes. This may be provided by replacing natural fibers in the laminate around the holes with an alternate material (e.g., carbon or fiberglass), positioning patches including the alternate material at the holes, respectively, or positioning full circumferential plies of the alternate material at the radially inner portion of the rim.

As another example, for a rim with access holes (e.g., within the radially outer tire engaging portion of the rim) for lacing, truing, or servicing a wheel, the laminate may include carbon or fiberglass, for example, around the access holes. This may be provided by replacing natural fibers in the laminate around the access holes with an alternate material (e.g., carbon or fiberglass), positioning patches including the alternate material at the access holes, respectively, or positioning full circumferential plies including the alternate material at the radially outer tire engaging portion of the rim.

As yet another example, electronics or other devices may be housed within a cavity formed in a rim, and the cavity (e.g., a hole or a pocket) may be sealed through the use of an inherently sealed laminate including, for example, carbon or fiberglass around the cavity. This may be provided locally to avoid degrading the transmissivity of radio waves through the natural fiber laminate for wireless electronics.

Composites may require deflashing or removal of unwanted resin from a molding process. This process may expose fibers, and, for example, carbon fiber, fiberglass, or another inherently sealed material may be used locally to seal the laminate.

Common manufacturing processes used for manufacturing carbon composite bicycle parts such as rims, for example, may be used to manufacture natural fiber (e.g., flax fiber) and carbon fiber composite rims (e.g., flax carbon hybrid rims). For example, manufacturing processes such as press curing, autoclave curing, oven curing, and/or resin transfer molding may be used. The flax carbon hybrid rims may also be shaped using, for example, a bladder or a material that applies pressure to a laminate due to heat growth (e.g., silicone in a constricted mold tool).

Natural fiber composites have an advantageous combination of low material density, an appropriate range of specific stiffness, and signal transmissivity. An advantage of using a disclosed natural fiber composite for a bicycle part is that the weight of the bicycle part may be reduced for structures that are not heavily dependent on specific fiber tensile strength. Another advantage is an increase in vibration damping in bicycle parts, which reduces locomotive energy losses while increasing comfort and control. Other advantages are a reduction in noise from the bicycle parts due to an increase in sound attenuation, and more ductile failure responses being created, which leads to less catastrophic failures often associated with carbon composites.

The disclosed laminate includes both a natural fiber composite material and an inherently solid and non-moisture wicking composite material. The natural fiber composite material may be used in easily sealed areas of the rim (e.g., sidewalls that do not include any openings or holes), and the inherently solid and non-moisture wicking composite material may be used in areas of the rim that are difficult to seal (e.g., at holes through the radially inner portion of the rim and/or the radially outer tire engaging portion of the rim). Such a laminate includes the benefits of natural fiber composites (e.g., an advantageous combination of low material density, an appropriate range of signal stiffness, and signal transmissivity), while preventing or slowing moisture degradation.

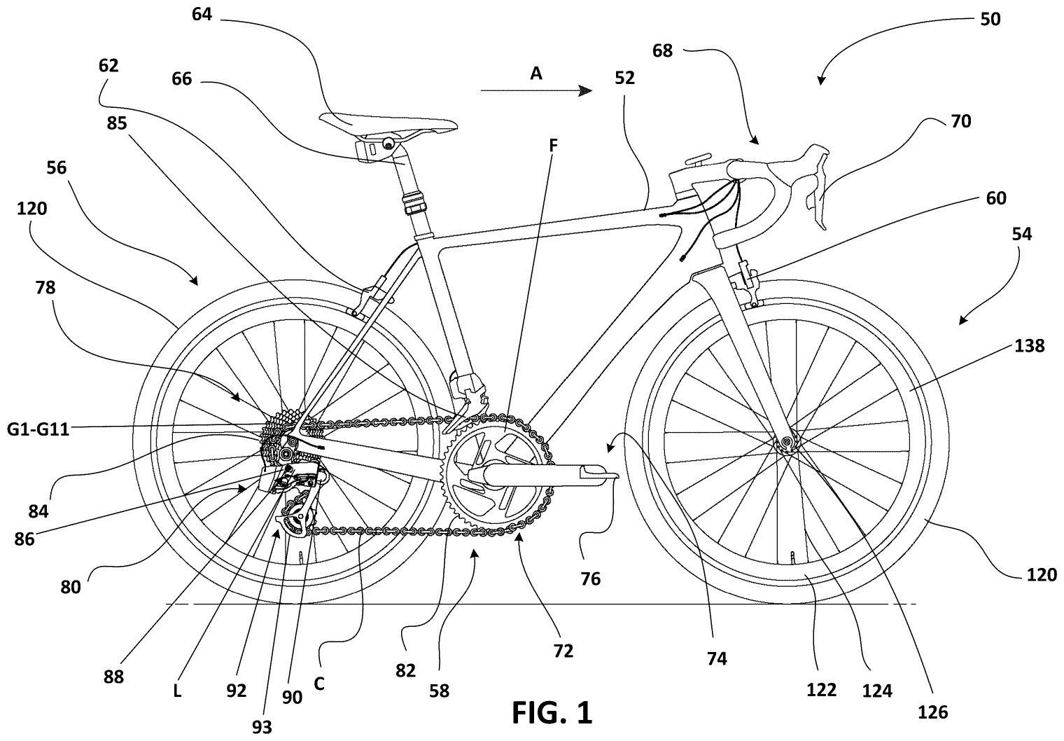

Turning now to the drawings, FIG. 1 generally illustrates a bicycle 50 that employs rims constructed in accordance with the teachings of the present disclosure. The bicycle 50 includes a frame 52, a front wheel 54 and a rear wheel 56 each rotatably attached to the frame 52, and a drivetrain 58. A front brake 60 is provided for braking the front wheel 54, and a rear brake 62 is provided for braking the rear wheel 56. The bicycle 50 also generally has a seat 64 near a rear end of the frame 52 and carried on an end of a seat post 66 connected to the frame 52. The bicycle 50 also has handlebars 68 near a forward end of the frame 52. A brake lever 70 is carried on the handlebars 68 for actuating the front brake 60, the rear brake 62, or both the front brake 60 and the rear brake 62. If the brake lever 70 actuates only one of the front brake 60 and the rear brake 62, a second brake lever (not shown) may also be provided to actuate the other brake. A front and/or forward riding direction or orientation of the bicycle 50 is indicated by the direction of the arrow A in FIG. 1. As such, a forward direction for the bicycle 50 is indicated by the direction of arrow A. While the illustrated bicycle 50 depicted in FIG. 1 is a road bike having drop-style handlebars 68, the present disclosure may be applicable to bicycles of any type, including mountain bikes with full or partial suspensions.

The drivetrain 58 has a chain C and a front sprocket assembly 72, which is coaxially mounted with a crank assembly 74 having pedals 76. The drivetrain 58 also includes a rear sprocket assembly 78 coaxially mounted with the rear wheel 56 and a rear gear change mechanism, such as a rear derailleur 80.

As is illustrated in FIG. 1, the front sprocket assembly 72 may include one or more coaxially mounted chainrings, gears, or sprockets. In this example, the front sprocket assembly 72 has one sprocket F. The one sprocket F has teeth 82 around a respective circumference. As shown in FIG. 1, the rear sprocket assembly 78 may include a plurality of coaxially mounted gears, cogs, or sprockets G. Each sprocket G1-G11 also has teeth 84 arranged around a respective circumference. The number of teeth 84 on the rear sprockets G1-G11 may gradually decrease from the largest diameter rear sprocket G1 to the smallest diameter sprocket G11. Though not described in any detail herein, a front gear changer 85 may be operated to move from a first operating position to a second operating position to move the chain C between front sprockets F. Likewise, the rear derailleur 80 may be operable to move between different operating positions to switch the chain C to a selected one of the rear sprockets G1-G11. In an embodiment, the rear sprocket assembly 78 may have more or fewer sprockets G. For example, in an embodiment, the rear sprocket assembly 78 may have twelve or thirteen sprockets. Dimensions and configuration of the rear derailleur 80 may be modified to accommodate a specific implemented plurality of sprockets. For example, an angle and length of a linkage and/or a configuration of a cage of the rear derailleur 80 may be modified to accommodate specific sprocket combinations.

The rear derailleur 80 is depicted as a wireless, electrically actuated rear derailleur mounted or mountable to the frame 52, or frame attachment, of the bicycle 50. The electric rear derailleur 80 has a base member 86 (e.g., a b-knuckle) that is mounted to the bicycle frame 52. A linkage 88 has two links L that are pivotally connected to the base member 86 at a base member linkage connection portion. A movable member 90 (e.g., a p-knuckle) is connected to the linkage 88 at a moveable member linkage connection portion. A chain guide assembly 92 (e.g., a cage) is configured to engage and maintain tension in the chain and has one or more cage plates 93 with a proximal end that is pivotally connected to a part of the movable member 90. The cage plate 93 may rotate or pivot about a cage rotation axis in a damping direction and a chain tensioning direction. Other gear changing systems, such as mechanically or hydraulically controlled and/or actuated systems may also be used.

A motor module may be carried on the electric rear derailleur 80 with a battery. The battery supplies power to the motor module. In one example, the motor module is located in the movable member 90. However, the motor module may instead be located elsewhere, such as in one of the links L of the linkage 88 or in the base member 86. The motor module may include a gear mechanism or transmission. As is known in the art, the motor module and gear mechanism may be coupled with the linkage 88 to laterally move the cage plate 93 and thus switch the chain C among the rear sprockets (e.g., G1-G11) on the rear sprocket assembly 78.

The cage plate 93 also has a distal end that carries a tensioner cog or wheel. The wheel also has teeth around a circumference. The cage plate 93 is biased in a chain tensioning direction to maintain tension in the chain C. The chain guide assembly 92 may also include a second cog or wheel, such as a guide wheel disposed nearer the proximal end of the cage plate 93 and the movable member 90. In operation, the chain C is routed around one of the rear sprockets (e.g., G1-G11). An upper segment of the chain C extends forward to the front sprocket assembly 72 and is routed around the one front sprocket F. A lower segment of the chain C returns from the front sprocket assembly 72 to the tensioner wheel and is then routed forward to the guide wheel. The guide wheel directs the chain C to the rear sprockets (e.g., G1-G11). Lateral movement of the cage plate 93, the tensioner wheel, and the guide wheel may determine the lateral position of the chain C for alignment with a selected one of the rear sprockets (e.g., G1-G11).

The bicycle 50 may include one or more bicycle control devices mounted to handlebars 68. The bicycle control devices may include one or more types of bicycle control and/or actuation systems. For example, the bicycle control devices may include brake actuation systems to control the front brake 60 and/or the rear brake 62, and/or gear shifting systems to control the drivetrain 58. Other control systems may also be included. For example, the system may be applied, in some embodiments, to a bicycle where only a front or only a rear gear changer is used. Also, the one or more bicycle control devices may also include suspension, seat post, and/or other control systems for the bicycle 50.

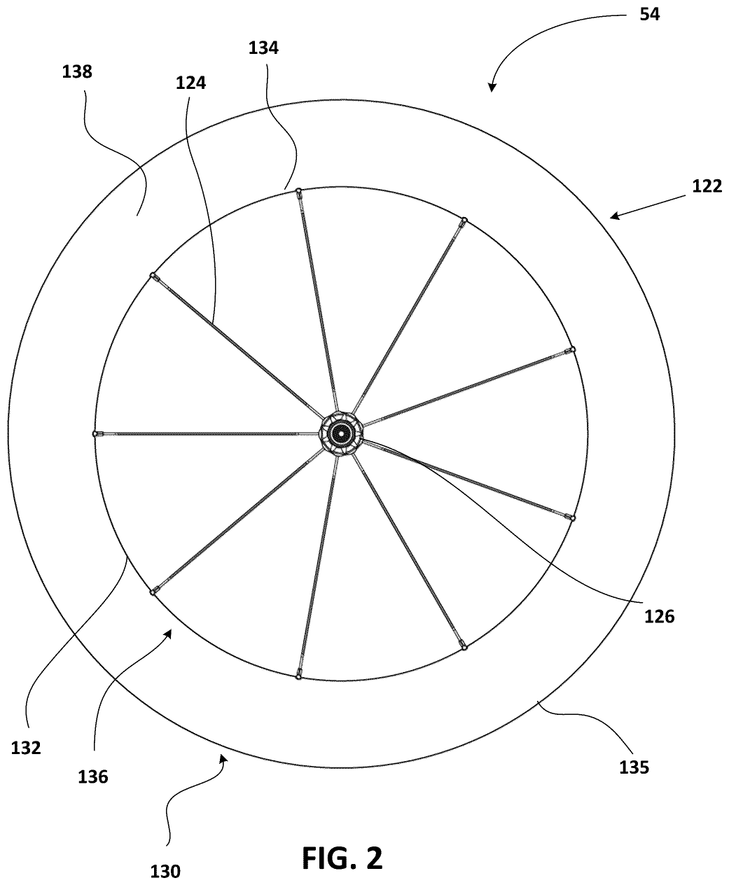

The front wheel 54 and/or the rear wheel 56 of the bicycle 50 may include a tire 120 attached to a radially outer tire engaging portion of a rim 122. As shown in FIGS. 1 and 2, a plurality of spokes 124 are attached directly to the rim 122. Alternatively, the spokes 124 may be attached and/or secured to the rim 122 with other structural components. The spokes 124 extend from the rim 122 and attach to a central hub 126. The spokes 124 are maintained with a tension between the rim 122 and the central hub 126 to provide the respective wheel 54, 56 with an operational rigidity for use on the bicycle 50. The central hub 126 is configured for rotational attachment to the bicycle frame 52.

FIG. 2 illustrates a bicycle wheel having a rim 122, spokes 124, and a central hub 126, such as the front wheel 54 of FIG. 1, removed from the rest of the bicycle 50 and without a tire attached. The rim 122 includes a tire engaging portion 130 to engage with the tire 120, as is shown in FIG. 1. The tire engaging portion 130 is configured radially outward of a spoke receiving surface 132 that is disposed along an inner circumference 134 of the rim 122. In other words, the tire engaging portion 130 is a radially outer tire engaging portion. In an embodiment, the tire engaging portion 130 is disposed along an outer circumference 135 of the rim 122. The tire engaging portion 130 is configured for attachment to tires using clincher tire attachment configurations for tires including beaded interlock attachments. Other configurations of the tire engaging portion 130 may also be provided to allow for the use of other types of tires on the rim 122. For example, tubeless tires including beaded interlock attachment types may be used.

The rim 122 provides structure for attachment of the spokes 124 to the rim 122 at a receiving portion of the rim 122, proximate to the spoke receiving surface 132. As such, the spoke receiving surface 132 is part of a spoke engaging portion 136 (e.g., a radially inner portion) of the rim 122. In an embodiment, the spoke engaging portion 136 of the rim 122 is disposed along the inner circumference 134 of the rim 122. In another embodiment, the spoke receiving surface 132 and the spoke engaging portion 136 may be separate parts and/or portions of the rim 122. For example, the spokes 124 may pass through the spoke receiving surface 132, and the structure for attachment to the rim 122 may be provided proximate to the tire engaging portion 130.

The rim 122 includes a first sidewall 138 and a second sidewall that extend between the tire engaging portion 130 and the spoke engaging portion 136. For example, the first sidewall 138 and the second sidewall extend radially outward from the spoke engaging portion 136 to the tire engaging portion 130. The first sidewall 138 is spaced apart from the second sidewall.

At least part of the rim 122 (e.g., the spoke engaging portion 136 and/or the tire engaging portion 130) is formed by one or more composite materials. In one embodiment, the entire rim 122 is formed by two or more composite materials. Other configurations may also be provided. For example, a combination of natural fiber reinforced plastic and carbon-fiber reinforced plastic forms a one-piece unitary rim of a collection of natural fiber layers and carbon-fiber layers including the tire engaging portion 130, the first sidewall 138, the second sidewall, and the spoke engaging portion 136.

The front wheel 54 and the rear wheel 56 may include rims 122 configured for any size wheel. In an embodiment, the rims 122 are configured for use in wheels conforming to a 700 C (e.g., a 622 millimeter diameter clincher and/or International Standards Organization 622 mm) bicycle wheel standard.

The front wheel 54 and the rear wheel 56 may rotate about the central hub 126 in either direction. For example, as shown in FIG. 2, the front wheel 54 and the rear wheel 56 may be configured to rotate in a particular rotational direction about the central hub 126. In another example, the front wheel 54 and the rear wheel 56 may be configured to rotate in a direction opposite the particular rotational direction.

In one embodiment, the first sidewall 138, the second sidewall, the spoke engaging portion 136, and the tire engaging portion 130 of the front wheel 54 and/or the rear wheel 56 of the bicycle 50 (e.g., the front wheel 54 and the rear wheel 56 in the example of FIG. 1) are at least partially formed by one or more layers of the one or more composite materials (e.g., layers of composite materials). Each of the one or more layers may include one or more fabric plies (e.g., pieces) of the respective composite material. Different layers of different composite materials may include different numbers of plies or pieces of the composite materials, respectively. At least some of the layers of composite material may be of different shapes and/or sizes. Alternatively, all of the layers of the composite material may be a same shape and/or size.

In one embodiment, at least some of the layers of composite material are shaped as strips. For example, strips of the one or more composite materials may form the first sidewall 138 and the second sidewall of the front wheel 54. The strips of the one or more composite materials may be disposed about the central hub 126 of the front wheel 54, respectively, and the central hub 126 of the rear wheel 56, respectively, to form the first sidewall 138 and the second sidewall of the front wheel 54 and the rear wheel 56, respectively.

In a manufacturing process, the layers of the front wheel 54 and the rear wheel 56, respectively, are integrated with the spoke engaging portion 136 and the tire engaging portion 130 (e.g., layers of composite material forming the spoke engaging portion 136 and the tire engaging portion 130) of the respective wheel 54, 56 by, for example, a curing process, such that a one-piece unitary rim 122 is formed. The rims 122 of the front wheel 54 and rear wheel 56, respectively, may be formed with other manufacturing processes.

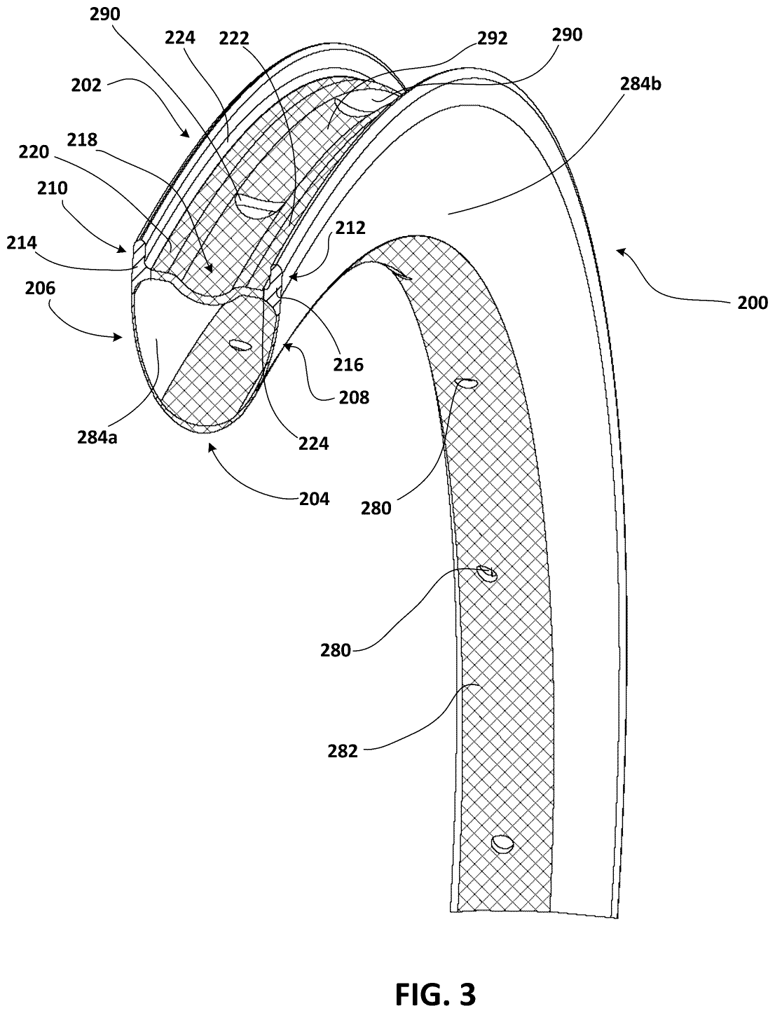

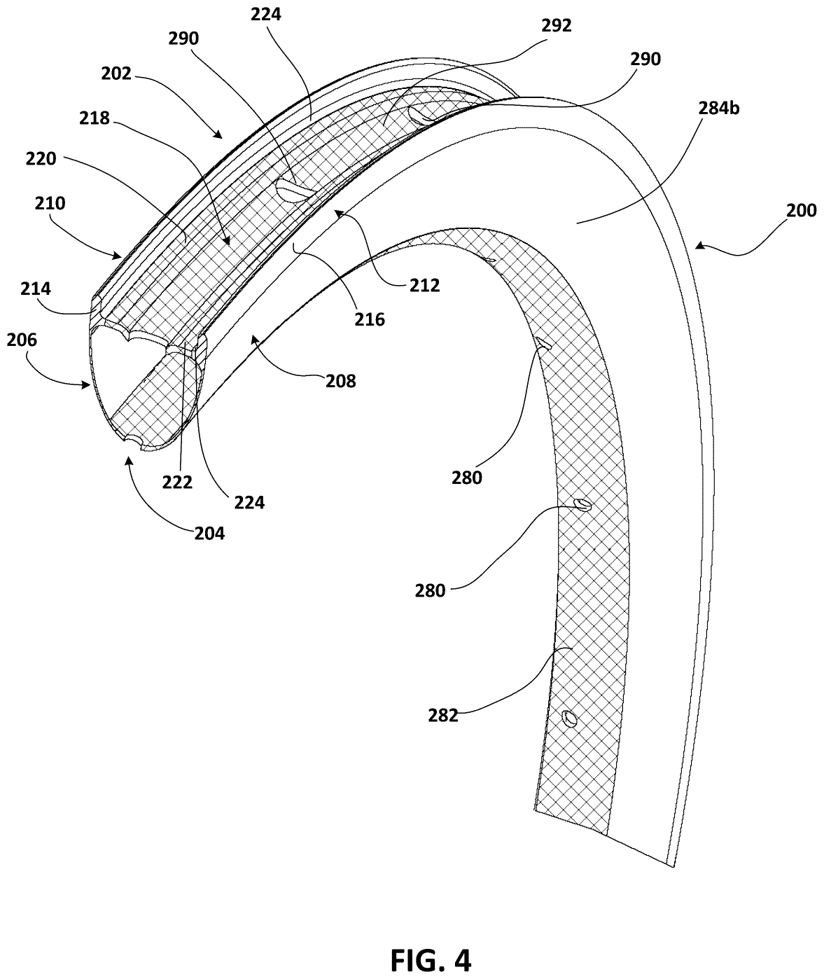

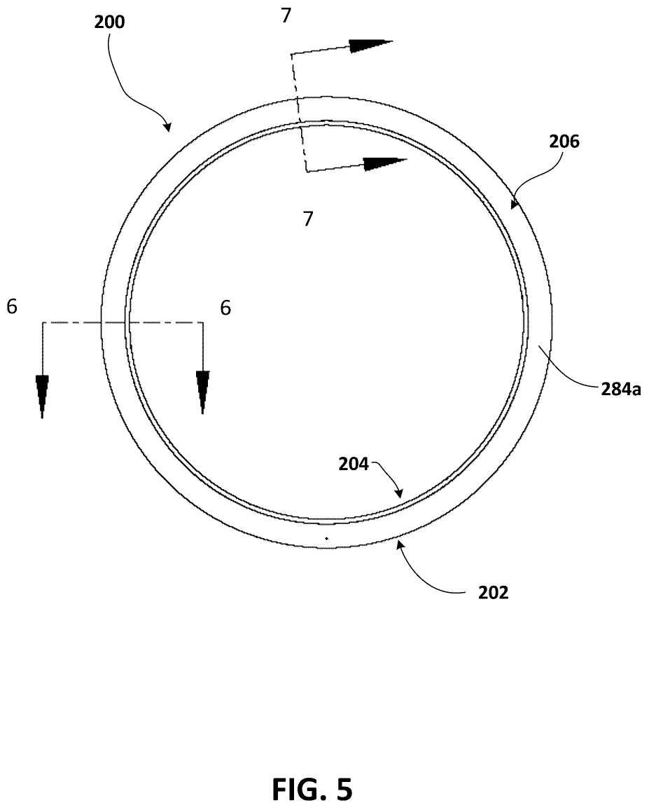

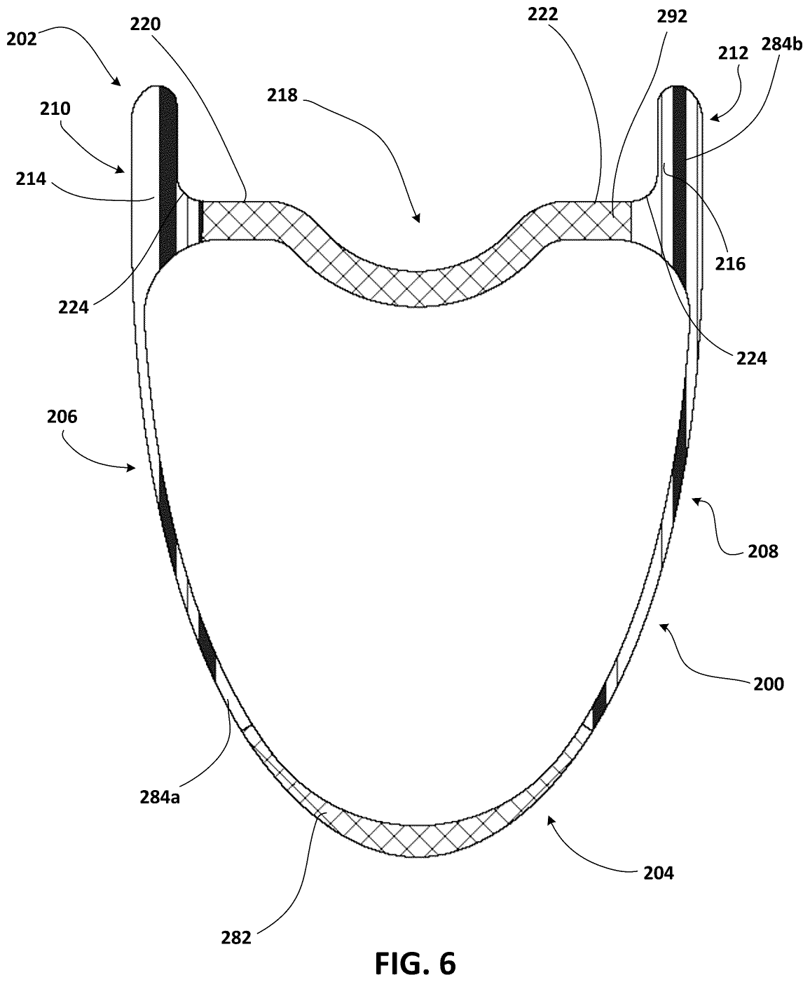

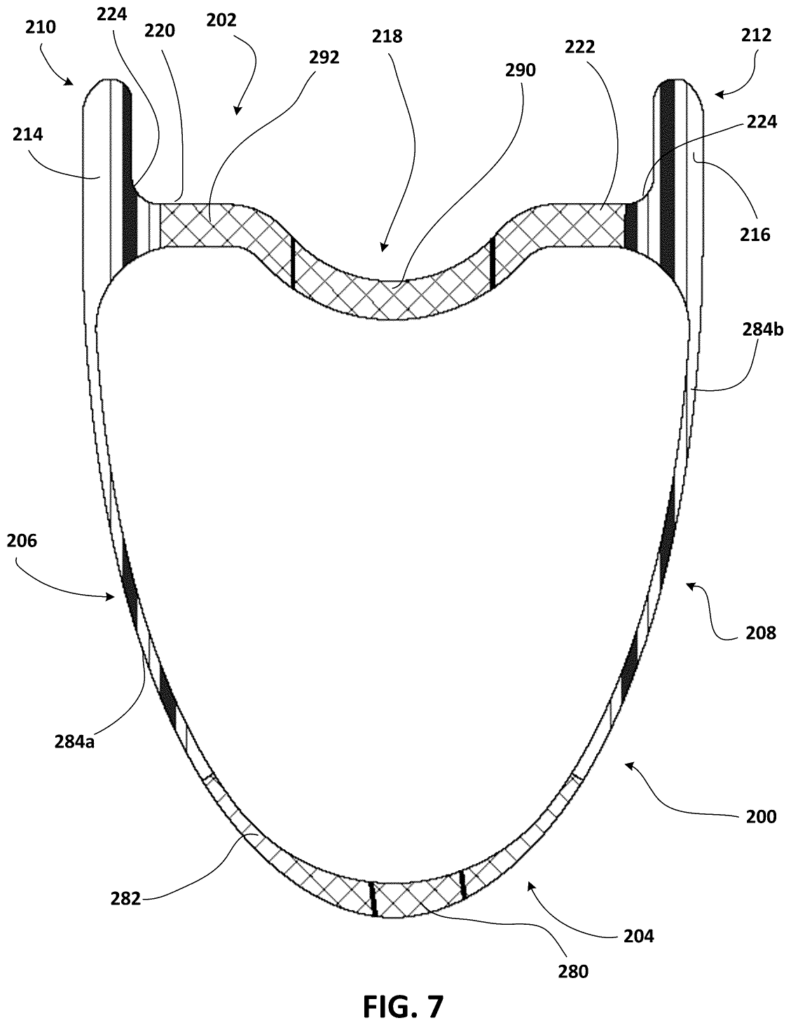

FIGS. 3-7 show a first embodiment of a composite rim 200 formed by layers of multiple composite materials. A layup pattern of layers of composite material for the rim is provided prior to a curing process, for example, to form the rim 200. The layers of the multiple composite materials, after the curing process, may be part of a one-piece unitary rim 200. The resultant one-piece unitary rim 200 may be formed by a composite laminate that includes one or more compressed layers of one or more composite materials.

Any number of composite materials may be included within the composite laminate. For example, the one or more composite materials of the composite laminate may include a first composite material, a second composite material, a third composite material, or any combination thereof. The composite laminate may include more or fewer composite materials. For example, the composite laminate may include only the first composite material and the second composite material, or may include only the second composite material and the third composite material.

A number of natural fibers provide a combination of low material density (e.g., compared to fiberglass) with a sufficient range of specific stiffness for a number of different types of bicycle components (e.g., bicycle rims, crankarms, handlebars, stems, seat posts, seat rails, shifting levers, brake levers, derailleur cages, suspension fork components). For example, flax has a density of less than 1.5 g/cm³ (e.g., compared to a density of more than 2.5 g/cm³ for fiberglass), a specific modulus of 43 GPa/(g/cm³) (e.g., compared to 28 GPa/(g/cm³) for fiberglass), and a specific ultimate strength of 500 MPa/(g/cm³) (e.g., compared to 1,390 MPa/(g/cm³) for fiberglass). As another example, hemp has a density of less than 1.5 g/cm³, a specific modulus of 30 GPa/(g/cm³), and a specific ultimate strength of 372 MPa/(g/cm³).

The combination of a cellulose structure with unique specific stiffness properties, specific modulus properties, and processability characteristics damp vibrations, increase sound attenuation, and provide for a more ductile failure compared to composites used in the prior art (e.g., fiberglass). Low-density cellulose composites (e.g., flax fiber composites) are non-conductive, which allow for electrical signals to pass through the composite, unlike carbon fiber composites, which act as a Faraday cage blocking signals.

Referring to FIGS. 3, 6, and 7, the composite rim 200 includes a radially outer tire engaging portion 202 (e.g., disposed along an outer circumference of the composite rim 200), a radially inner portion 204 (e.g., a spoke engaging portion), a first sidewall 206, and a second sidewall 208 spaced apart from the first sidewall 206. The first sidewall 206 and the second sidewall 208 extend radially outward from the radially inner portion 204, to the radially outer tire engaging portion 202. The radially outer tire engaging portion 202 extends from the first sidewall 206 to the second sidewall 208, respectively.

The radially outer tire engaging portion 202 of the composite rim 200 includes a first tire retaining portion 210 and a second tire retaining portion 212 spaced apart from the first tire retaining portion 210. The first tire retaining portion 210 extends from the first sidewall 206, and the second tire retaining portion 212 extends from the second sidewall 208.

The first tire retaining portion 210 includes a first tire retaining wall 214. In one embodiment, the first tire retaining portion 210 also includes a first protrusion (e.g., a first tire retaining feature) (not shown). The first protrusion may extend away from the first tire retaining wall 214. The first protrusion may be any number of shapes including, for example, a shape having a cross-section that is rectangular with a semi-circle cap. The first protrusion may extend circumferentially around the composite rim 200.

The second tire retaining portion 212 includes a second tire retaining wall 216. The second tire retaining wall 216 is opposite and spaced apart from the first tire retaining wall 214. In one embodiment, the second tire retaining portion 212 also includes a second protrusion (e.g., a second tire retaining feature) (not shown). The second protrusion may extend away from the second tire retaining wall 216, towards the first tire retaining portion 210. The second protrusion may be any number of shapes including, for example, a shape having a cross-section that is rectangular with a semi-circle cap. The second protrusion may extend circumferentially around the composite rim 200. The first protrusion and the second protrusion may be other shapes.

The composite rim 200 may seat a tire 120 (see FIG. 1) that is, for example, a tubeless clincher tire. The tire 120 includes beads that interact with the radially outer tire engaging portion 202 (e.g., the first tire retaining portion 210 and the second tire retaining portion 212) of the composite rim 200 to attach the tire 120 to and maintain the tire 120 on the composite rim 200. The beads may include any number of materials within the beads, such as, for example, a steel wire or aramid (e.g., Kevlar™) fiber, to prevent the tire 120 from moving off of the composite rim 200. Due to the reinforcement with the steel wire or the Kevlar™ fiber, for example, the beads resist stretching from internal air pressure. Alternatively, the beads may be made of a same material as the tire 120 (e.g., rubber).

The radially outer tire engaging portion 202 also includes a well 218 positioned between the first tire retaining portion 210 and the second tire retaining portion 212 of the composite rim 200. The well 218 provides a volume into which the beads of the tire 120 may be placed when the tire 120 is being attached to the composite rim 200. As the tire 120 is inflated, the beads of the tire 120 move away from each other until the beads interact with the first tire retaining portion 210 and the second tire retaining portion 212, respectively. When inflated, the beads of the tire 120 abut the first tire retaining wall 214 and the second tire retaining wall 216, respectively. In one embodiment, the first tire retaining feature and the second tire retaining feature, for example, keep the beads of the tire 120 positioned within the radially outer tire engaging portion 202 (e.g., keep the beads of the tire 120 engaged with the first tire retaining wall 214 and the second tire retaining wall 216) and thus keep the tire 120 from blowing off the composite rim 200. The contact between the beads and the first tire retaining wall 214 and the second tire retaining wall 216, respectively, forms a seal between the inflated tire 120 and the composite rim 200.

The radially outer tire engaging portion 202 may also include ridges (e.g., bead bumps; a first bead bump and a second bead bump) on opposite sides of the well 218, respectively. A first shelf 220 (e.g., a first bead shelf) extends away from the first tire retaining wall 214 (e.g., between the first tire retaining wall 214 and the first bead bump), and a second shelf 222 (e.g., a second bead shelf) extends away from the second tire retaining wall 216 (e.g., between the second tire retaining wall 216 and the second bead bump). In one embodiment, curved transition regions 224 extend between the first shelf 220 and the first tire retaining wall 214, and the second shelf 222 and the second tire retaining wall 216, respectively. The bead bumps may be positioned on opposite sides of the well 218, respectively, and may be raised relative to the first shelf 220 and the second shelf 222, respectively. The bead bumps may help retain the tire 120 on the composite rim 200 if the tire 120 loses pressure.

Referring to FIGS. 3-7, at least part of the first sidewall 206 and part of the second sidewall 208 may be made of the first composite material. In one embodiment, at least part of the radially outer tire engaging portion 202 (e.g., the first tire retaining portion 210 and the second tire retaining portion 212) is also made of the first composite material. In one embodiment, at least part of the radially inner portion 204 is made of the first composite material.

The first composite material may include a matrix of a first polymer-based material and natural fibers of a first reinforcing material. In one example, the first reinforcing material has a specific modulus between 24 and 60 GPa/(g/cm³) and a specific strength below 600 MPa/(g/cm³). Alternatively, or additionally, the first reinforcing material may have a cellulose content above 40% and a hemicellulose content above 4%. The first polymer-based material may be any number of materials including, for example, a thermoplastic, a thermoset matrix, another polymer-based material, or any combination thereof, and the natural fibers of the first reinforcing material may be any number of materials including, for example, flax fibers. Other reinforcing materials may be used. For example, in other embodiments, kenaf fibers, hemp fibers, jute fibers, sisal fibers, one or more other natural fibers, or any combination thereof may be used.

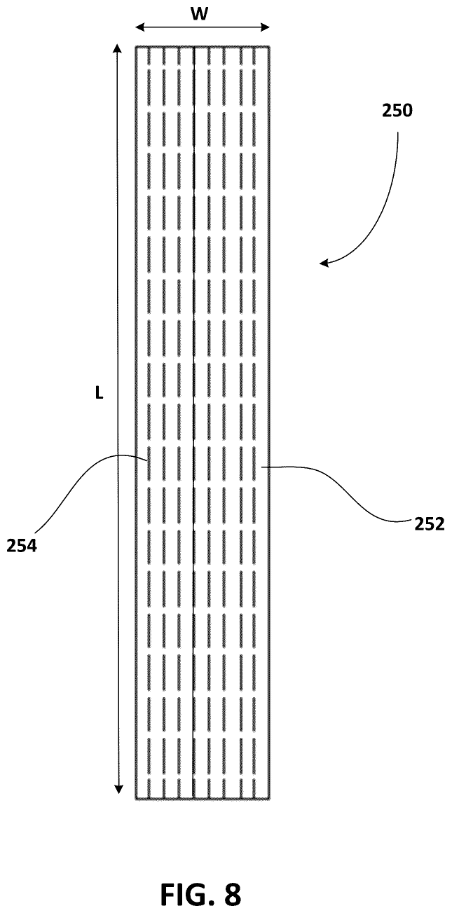

FIG. 8 illustrates one embodiment of a layer 250 of the first composite material shaped as a strip. The first composite material includes a matrix 252 of a polymer-based material (e.g., the first polymer-based material) and fibers 254 of a reinforcing material (e.g., the first reinforcing material). In one embodiment, the first polymer-based material is, for example, a thermoplastic or a thermoset. In one embodiment, the fibers 254 of the first reinforcing material are, for example, flax fibers. Other polymer-based materials and/or other reinforcing fibers may be used.

The fibers 254 extend along a finite length L of the strip 250. In one embodiment, the fibers 254 extend in a primary strength direction of the strip 250 (e.g., along the length L of the strip 250). For example, the strip 250 has unidirectional fiber orientation along the length L. In another embodiment, some of the fibers 254 do not extend in the primary strength direction (e.g., less than 20 percent of the fibers, less than 10 percent of the fibers, or less than 5 percent of the fibers).

The strip 250 may be any number of shapes and/or sizes. For example, the strip 250 is rectangular in shape. Other shapes such as, for example, square shaped strips and non-rectangular parallelogram shaped strips, may be provided. The strip 250 also includes a width W that is perpendicular to the length L. The length L may be defined by a size of, for example, the radially outer tire engaging portion 202, the first sidewall 206, the second sidewall 208, and/or the radially inner portion 204 of the composite rim 200. In other words, the length L may be at least as tall or wide as the radially outer tire engaging portion 202, the first sidewall 206, the second sidewall 208, and/or the radially inner portion 204 of the composite rim 200. In one embodiment, the width W of the strip 250 is between 10 mm and 50 mm. For example, the width W of the strip 250 is 30 mm. In other embodiments, the strip 250 is wider or narrower (e.g., 60 mm). Smaller strip widths better optimize fiber orientation but come with a cost of added manufacturing complexity. In one embodiment, the width W of the strip 250 is as wide as a radial width of the composite rim 200.

Layers 250 of different shapes, greater width, and/or greater length may be used. For example, at least some of the layers of the first composite material may extend a quarter, half, or all the way around the rim. Different sized and/or shaped layers of the first composite material may be used depending on the application within the rim (e.g., forming an outer surface, providing strength and stiffness at a high load location within the rim).

The layer 250 of the first composite material may have any number of thicknesses. For example, the thickness of the layer 250 of the first composite material may be 0.4 mm or thinner (e.g., 0.25 mm or thinner). Other thicknesses of the layer 250 of the first composite material may be provided.

The layers 250, for example, provide ultimate strength in a direction of fiber grain. Accordingly, fiber alignment relative to an inner diameter of the composite rim 200 may be provided for increasing strength of the composite rim 200. The width W of the layer 250 is a variable in maximizing fiber alignment relative to a prescribed orientation. The further the fibers are from a center of the composite rim 200, the more the angle of the fiber relative to the rim tangent changes, which reduces the ability of the fiber to support stresses and load.

Referring to FIGS. 3-7, at least part of the first sidewall 206 and part of the second sidewall 208 may be made of the first composite material. At least part of the radially outer tire engaging portion 202 (e.g., the well 218, the first shelf 220, and the second shelf 222) and at least part of the radially inner portion 204 of the composite rim 200 may be made of the second composite material. In one embodiment, at least part of the first sidewall 206 and/or at least part of the second sidewall 208 is also made of the second composite material.

In one embodiment, a layer of the second composite material is shaped as a strip. The strip of the second composite material may be similar to the strip 250 of the first composite material shown in FIG. 8. For example, the second composite material also includes a matrix of a polymer-based material (e.g., the second polymer-based material) and fibers of a reinforcing material (e.g., the second reinforcing material). The second polymer-based material may be any number of materials including, for example, a plastic, an acrylic, a resin, an epoxy, or any combination thereof, and the fibers of the second reinforcing material may be any number of materials including, for example, carbon. Other polymer-based materials and/or other reinforcing fibers may be used.

The second reinforcing material may be denser and may have a greater specific modulus and specific ultimate strength compared to the first reinforcing material. For example, carbon has a density of, more than 2.5 g/cm³, but a specific modulus of 162 GPa/(g/cm³) and a specific strength of 2,952 MPa/(g/cm³). While carbon is heavier than the first reinforcing material, carbon and/or other denser but stronger reinforcing materials may be used to reinforce particular areas of the rim and prevent or reduce degradation of strength of the composite rim 200 (e.g., at the radially inner portion 204 of the composite rim 200). In one embodiment, the second composite material has a lower porosity than the first composite material and/or the third composite material.

Like the fibers 254 shown in FIG. 8, the fibers of the second reinforcing material may extend along a finite length of the strip. In one embodiment, the fibers of the second reinforcing material extend in a primary strength direction of the strip. For example, the strip of the second composite material has unidirectional fiber orientation along the length of the strip. In another embodiment, some of the fibers of the second reinforcing material do not extend in the primary strength direction (e.g., less than 20 percent of the fibers, less than 10 percent of the fibers, or less than 5 percent of the fibers).

The strip of the second composite material may be any number of shapes and/or sizes. For example, the strip of the second composite material is rectangular in shape. Other shapes such as, for example, square shaped strips and non-rectangular parallelogram shaped strips, may be provided.

The strip of the second composite material also includes a width W that is perpendicular to a length L. The width W may be defined by a size of, for example, the radially inner portion 204 of the composite rim 200. In one embodiment, the width W of the strip of the second composite material is between 10 mm and 50 mm. For example, the width W of the strip of the second composite material is 30 mm. In other embodiments, the strip of the second composite material is wider or narrower. The strip of the second composite material may have any number of thicknesses.

Layers of the second composite material of different shapes, greater width, and/or greater length may be used. For example, at least some of the layers of the second composite material may extend a quarter, half, or all the way around the composite rim 200 (e.g., as a portion of the radially inner portion 204). Different sized and/or shaped layers of the second composite material may be used depending on the application within the composite rim 200 (e.g., providing strength and stiffness at a high load location within the rim).

In one embodiment, at least part of the radially outer tire engaging portion 202 (e.g., the first tire retaining portion 210 and the second tire retaining portion 212) is also made of the third composite material. In one embodiment, at least part of the radially inner portion 204 is made of the third composite material.

The third composite material may include a matrix of a third polymer-based material and natural fibers of a third reinforcing material. In one example, the third reinforcing material has a specific modulus between 24 and 60 GPa/(g/cm³) and a specific strength below 600 MPa/(g/cm³). Alternatively, or additionally, the third reinforcing material may have a cellulose content above 40% and a hemicellulose content above 4%. The third polymer-based material may be any number of materials including, for example, a resin, an epoxy, or a combination thereof, and the natural fibers of the reinforcing material may be any number of materials including, for example, flax fibers. Other natural fibers of the reinforcing material such as, for example, kenaf fibers, hemp fibers, jute fibers, sisal fibers, one or more other natural fibers, or any combination thereof may be used. In one embodiment, the third reinforcing material is the same as the first reinforcing material (e.g., flax).

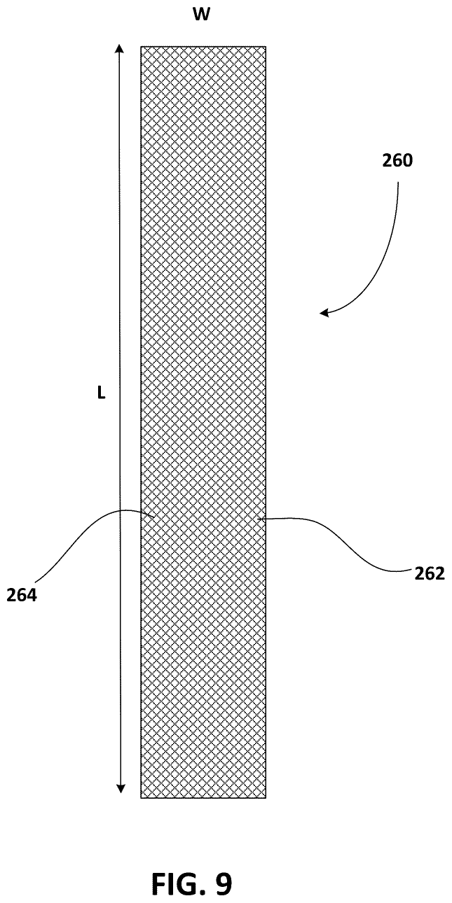

FIG. 9 illustrates one embodiment of a layer 260 of the third composite material shaped as a strip. The third composite material includes a matrix 262 of a polymer-based material (e.g., the third polymer-based material) and fibers 264 of a reinforcing material (e.g., the third reinforcing material). In one embodiment, the third polymer-based material is a resin, and the fibers of the third reinforcing material are flax fibers.

The fibers 264 are woven within the matrix 262 of the polymer-based material of the strip 260. Accordingly, at least some of the fibers 264 are at angles relative to others of the fibers 264. For example, at least some of the fibers 264 form a checkered pattern. In one embodiment, at least some of the fibers 264 extend along a length L of the strip 260. For example, less than 20 percent of the fibers 264, less than 10 percent of the fibers 264, or less than 5 percent of the fibers 264 extend along the length L of the strip 260. In an alternate embodiment, the fibers 264 of the strip 260 may be oriented in any direction. When flax is used as a low-density filler, the orientation of the fibers may be less significant. The fibers may not be oriented in the primary direction of the strip. In another alternate embodiment, the fibers 264 may be aligned with a load path that is different than the orientation of the strip.

The strip 260 may be any number of shapes and/or sizes. For example, the strip 260 is rectangular in shape. Other shapes such as, for example, square shaped strips and non-rectangular parallelogram shaped strips, may be provided. The strip 260 may include a width W that is perpendicular to a length L. The length L may be defined by a size of, for example, the radially outer tire engaging portion 202, the first sidewall 206, the second sidewall 208, and/or the radially inner portion 204 of the composite rim 200. In other words, the length L may be at least as tall or wide as the radially outer tire engaging portion 202, the first sidewall 206, the second sidewall 208, and/or the radially inner portion 204 of the composite rim 200. In one embodiment, the width W of the strip 260 is between 10 mm and 50 mm. For example, the width W of the strip 260 is 30 mm. In other embodiments, the strip 260 is wider or narrower (e.g., 60 mm). In one embodiment, the width W of the strip 260 is as wide as a radial width of the composite rim 200.

Layers 260 of different shapes, greater width, and/or greater length may be used. For example, at least some of the layers 260 of the third composite material may extend a quarter, half, or all the way around the rim (e.g., forming part of the well 218). Different sized and/or shaped layers 260 of the third composite material may be used depending on the application within the rim (e.g., providing thickness and stiffness at a high load location within the composite rim 200).

The layer 260 of the third composite material may have any number of thicknesses. In one embodiment, the layer 260 includes a number of plies of material and is thicker than the layer 250 of the first composite material. Each of the number of plies of material of the layer 260 of the third composite material may be unidirectional and may be stacked and sewn together, such that a checkered or hash pattern is formed. In other words, at least some of the number of plies of material of the layer 260 of the third composite material are unidirectional in different directions, respectively. For example, the thickness of the layer 260 of the third composite material may be 1.2 mm or thicker. Other thicknesses of the layer 260 of the third composite material may be provided.

Referring to FIGS. 3, 4, and 7, the radially inner portion 204 of the composite rim 200 includes a plurality of openings 280 that extend through the radially inner portion 204 of the composite rim 200. At least some openings of the plurality of openings 280 are, for example, spoke holes, through which spokes (e.g., the spokes 124) extend and at which the spokes are attached to the composite rim 200.

Any number of spoke holes 280 may be provided through the radially inner portion 204 of the composite rim 200. For example, the composite rim 200 may include 34 or 36 spoke holes 280 that extend through the radially inner portion 204 of the composite rim 200. In other embodiments, the composite rim 200 includes more or fewer spoke holes 280. The spoke holes 280, for example, may be any number of shapes (e.g., circular) and sizes (e.g., sized based on a size of a spoke and/or a spoke nipple to be attached to the composite rim 200 at the spoke holes 280).

The spoke holes 280 may be circumferentially distributed uniformly about the radially inner portion 204 of the composite rim 200, such that an arc length between adjacent spoke holes 280 is the same for each adjacent pair of spoke holes 280. In one embodiment, the distribution of the spoke holes 280 is varied (e.g., circumferentially or axially) about the radially inner portion 204 of the composite rim 200.

In one embodiment, all of the spoke holes 280 are centered within the radially inner portion 204 of the composite rim 200. In another embodiment, some or all of the spoke holes 280 are offset relative to a center of the radially inner portion 204 of the composite rim 200.

At least one first layer 282 of the second composite material forms at least part of the radially inner portion 204 of the composite rim 200, such that the second composite material (e.g., not the first composite material or the third composite material) surrounds each opening of the plurality of openings 280. In the embodiment shown in FIGS. 3-7, the at least one first layer 282 of the second composite material extends circumferentially, such that the at least one first layer 282 of the second composite material forms at least part of the radially inner portion 204 all of the way around the composite rim 200.

The at least one first layer 282 of the second composite material may be any number of shapes and/or sizes. For example, the at least one first layer 282 of the second composite material may be rectangular in shape and may extend all of the way around an inner circumference of the composite rim 200. As such, a length of the at least one first layer 282 of the second composite material may correspond to an inner circumference of the composite rim 200, and a width of the at least one first layer 282 of the second composite material may correspond to a width of the radially inner portion 204 of the composite rim 200. A thickness of the at least one first layer 282 of the second composite material may be uniform or may vary across the length and/or the width of the at least one first layer 282 of the second composite material. Other shapes and/or sizes may be provided.

In other embodiments, the radially inner portion 204 of the composite rim 200 includes additional openings. For example, the composite rim 200 includes a valve opening and/or one or more openings in which one or more electronic components for a bicycle (e.g., the bicycle 50) are respectively supportable. The at least one first layer 282 of the second composite material may also surround such openings through the radially inner portion 204 of the composite rim 200.

As shown in FIGS. 3-7, at least two layers 284a, 284b of the first composite material may form at least part of the first sidewall 206 and the second sidewall 208, respectively. The at least two layers 284a, 284b of the first composite material may also form part of the radially outer tire engaging portion 202. For example, a first layer 284a of the first composite material may at least partially form the first tire retaining portion 210 (e.g., the first tire retaining wall 214), and a second layer 284b of the first composite material may at least partially form the second tire retaining portion 212 (e.g., the second tire retaining wall 216).

Each of the at least two layers 284a, 284b of the first composite material may be any number of shapes and/or sizes. For example, each of the at least two layers 284a, 284b of the first composite material may be annular in shape and may extend all of the way around the composite rim 200. As such, a width of the respective layer 284a, 284b of the first composite material may correspond to a height of the first sidewall 206 or the second sidewall 208. In one embodiment, the width of the respective layer 284a, 284b of the first composite material may correspond to a height of the first tire retaining wall 214 or the second tire retaining wall 216 added to the height of the first sidewall 206 or the second sidewall 208, respectively. A thickness of each of the at least two layers 284a, 284b of the first composite material may be uniform or may vary around and/or across the width of the respective layer 284a, 284b of the first composite material. Other shapes and/or sizes may be provided.

Referring to FIGS. 3, 4, and 7, the radially outer tire engaging portion 202 of the composite rim 200 includes a plurality of openings 290 that extend through the radially outer tire engaging portion 202 of the composite rim 200. At least some openings of the plurality of openings 290 are, for example, access holes, through which the spokes (e.g., the spokes 124) may be accessed (e.g., tightened and loosened). The spokes may be accessed with, for example, a tool via the access holes 290

Any number of access holes 290 may be provided through the radially outer tire engaging portion 202 of the composite rim 200. The number of access holes 290 may correspond to the number of spoke holes 280. For example, the composite rim 200 may include 34 or 36 access holes 290 that extend through the radially outer tire engaging portion 202 of the composite rim 200. In other embodiments, the composite rim 200 includes more or fewer access holes 290. The access holes 290, for example, may be any number of shapes (e.g., circular) and sizes (e.g., sized based on a size of the tool with which the spokes may be tightened or loosened).

The access holes 290 may be circumferentially distributed uniformly about the radially outer tire engaging portion 202 of the composite rim 200, such that an arc length between adjacent access holes 290 is the same for each adjacent pair of access holes 290. In one embodiment, the distribution of the access holes 290 is varied (e.g., circumferentially or axially) about the radially outer tire engaging portion 202 of the composite rim 200 (e.g., corresponding to a varied distribution of the spoke holes 280).

In one embodiment, all of the access holes 290 are centered within the radially outer tire engaging portion 202 of the composite rim 200. For example, all of the access holes 290 are located within the well 218 (e.g., partially within the well 218 and partially within the first shelf 220 and the second shelf 222) of the radially outer tire engaging portion 202 of the composite rim 200. In another embodiment, some or all of the access holes 290 are offset relative to a center of the radially outer tire engaging portion 202 of the composite rim 200.

Referring to FIGS. 3, 4, 6, and 7, at least one second layer 292 of the second composite material forms at least part of the radially outer tire engaging portion 202 of the composite rim 200, such that the second composite material (e.g., not the first composite material or the third composite material) surrounds each opening of the plurality of openings 290. In the embodiment shown in FIGS. 3-7, the at least one second layer 292 of the second composite material extends circumferentially, such that the at least one second layer 292 of the second composite material forms at least part of the radially outer tire engaging portion 202 all of the way around the composite rim 200.

The at least one second layer 292 of the second composite material may be any number of shapes and/or sizes. For example, the at least one second layer 292 of the second composite material may be rectangular in shape prior to curing of the composite laminate and may be u-shaped after curing of the composite laminate. The second layer 292 of the second composite material may extend all of the way around an outer circumference of the composite rim 200. As such, a length of the at least one second layer 292 of the second composite material may correspond to an outer circumference of the composite rim 200, and a width of the at least one second layer 292 of the second composite material may correspond to a width of at least part of the radially outer tire engaging portion 202 (e.g., the well 218, the first shelf 220, and the second shelf 222) of the composite rim 200. A thickness of the at least one second layer 292 of the second composite material may be uniform or may vary across the length and/or the width of the at least one second layer 292 of the second composite material. Other shapes and/or sizes may be provided.

In other embodiments, the radially outer tire engaging portion 202 of the composite rim 200 includes additional openings. The at least one second layer 292 of the second composite material may also surround such openings through the radially outer tire engaging portion 202 of the composite rim 200.

Within a layup pattern prior to curing, for example, the at least one first layer 282 of the second composite material may abut the at least two layers 284a, 284b of the first composite material, and the at least one second layer 292 of the second composite material may abut the at least two layers 284a, 284b of the first composite material, such that after curing, for example, a one-piece unitary rim 200 is formed. In one embodiment, prior to curing, portions on opposite sides of the at least one first layer 282 of the second composite material may overlap the at least two layers 284a, 284b of the first composite material, respectively, and portions on opposite sides of the at least one second layer 292 of the second composite material may overlap the at least two layers 284a, 284b of the first composite material, respectively.

In one embodiment, one or more layers of the third composite material may be included within the composite laminate of the composite rim 200 to provide thickness and stiffness at a lower cost compared to only using layers of the first composite material. In one embodiment, the layers of the third composite material may not form any outer surfaces of the composite rim 200 (e.g., except for outermost portions of the first tire retaining wall 214 and the second tire retaining wall 216, respectively). For example, a first layer of the third composite material partially forms the first sidewall 206 and abuts the first layer 284a of the first composite material, and a second layer of the third composite material partially forms the second sidewall 208 and abuts the second layer 284b of the first composite material.

Surrounding holes (e.g., the spoke holes 280 and the access holes 290) through the composite rim 200 with the second composite material (e.g., a carbon fiber composite) reduces or prevents moisture degradation of the composite rim 200 at the holes. The second composite material (e.g., the carbon fiber composite) is an inherently solid and non-moisture wicking material.

Other configurations may be provided. For example, the composite laminate of the composite rim 200 may include more, fewer, and/or different composite materials. As another example, the composite laminate of the composite rim 200 may include more, fewer, and/or different layers. The composite laminate of the composite rim 200 for the front wheel 54, for example, may be the same as the composite laminate for the composite rim 200 for the rear wheel 56, for example. Alternatively, the composite laminates for the composite rims 200 for the front wheel 54 and the rear wheel 56, respectively, for example, may be different.

Each layer (e.g., first, second, etc.) of composite material (e.g., first, second, third, etc. composite materials) of the previous embodiment shown in FIGS. 3-7 may be made up of multiple plies of strips. The plies of strips of each layer of composite material are connected. For example, the plies of strips of each layer of composite material may be connected in an overlapping pattern, or an interleaving pattern, forming the composite rim 200 shown in FIG. 3. Other patterns known by those of skill in the art may be used to form the composite rim 200.

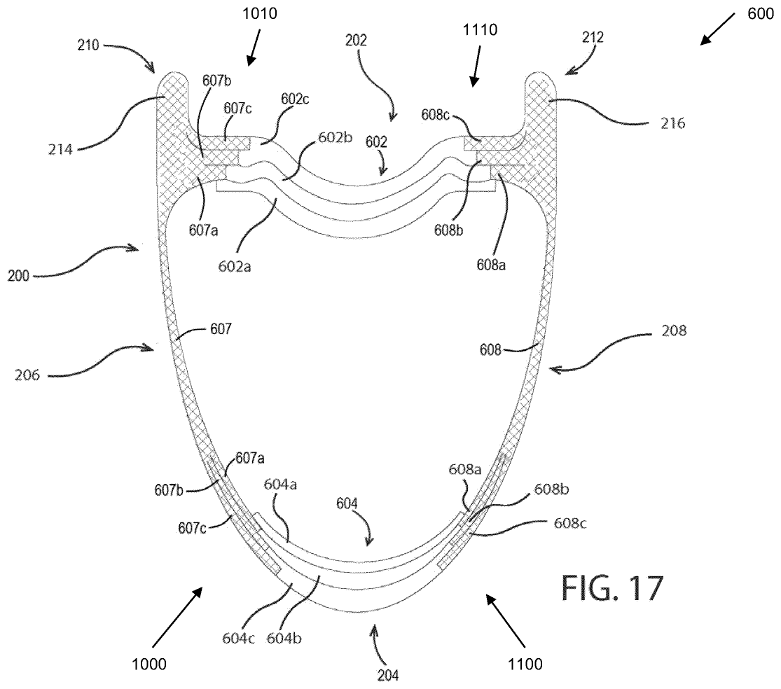

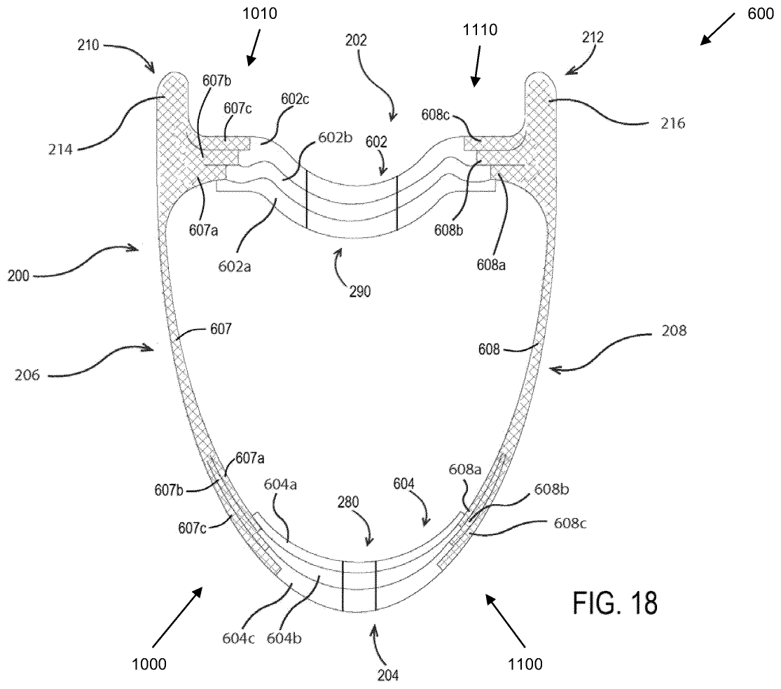

FIGS. 17-18 depict the construction of a rim 600 using an overlapping pattern. For example, the rim 200 in the embodiment of FIGS. 3-7 may be constructed using this overlapping pattern. Specifically, a first layer 604 of the second composite material may be attached to a first layer 607 of the first composite material at an overlapping joint 1000. The first layer 604 of the second composite material may be attached to a second layer 608 of the first composite material at an overlapping joint 1100. A second layer 602 of the second composite material may be attached to the first layer 607 of the first composite material at an overlapping joint 1010. The second layer 602 of the second composite material may be attached to the second layer 608 of the first composite material at an overlapping joint 1110.

The first layer 604 of the second composite material forms at least part of the radially inner portion 204 of the composite rim 600. The first layer 604 of the second composite material surrounds each opening of the plurality of openings 280. The first layer 604 of the second composite material consists of three plies of strips. The plies of strips include a first ply 604a, a second ply 604b, and a third ply 604c. The first ply 604a is the inner most ply. The first ply 604a is further from the outside surface of the rim 600 than the second ply 604b and the third ply 604c. The third ply 604c is the outermost ply. The third ply 604c forms at least a portion of the outer surface of the rim 600. The second ply 604b is located between the first ply 604a and the third ply 604c.

In the example embodiment, as shown in FIGS. 17-18, the two layers 607, 608 of the first composite material may form at least part of the first sidewall 206 and the second sidewall 208, respectively. The two layers 607, 608 of the first composite material may also form part of the radially outer tire engaging portion 202. For example, the first layer 607 of the first composite material may at least partially form the first tire retaining portion 210 (e.g., the first tire retaining wall 214). The second layer 608 of the first composite material may at least partially form the second tire retaining portion 212 (e.g., the second tire retaining wall 216).

In the example embodiment shown in FIGS. 17-18, the first layer 607 consists of three plies of strips. The plies of strips include a first ply 607a, a second ply 607b, and a third ply 607c. The first ply 607a is the innermost ply. The first ply 607a is further from the outside of the rim 600 than the second ply 607b and the third ply 607c. The third ply 607c is the outermost ply. The third ply 607c forms at least a portion of the outer surface of the rim 600. The second ply 607b is located between the first ply 607a and the third ply 607c.

The second layer 608 consists of three plies of strips. The plies of strips include a first ply 608a, a second ply 608b, and a third ply 608c. The first ply 608a is the innermost ply. The first ply 608a is further from the outside of the rim 600 than the second ply 608b and the third ply 608c. The third ply 608c is the outermost ply. The third ply 608c forms at least a portion of the outer surface of the rim 600. A second ply 608b is located between the first ply 608a and the third ply 608c.

In the example embodiment shown in FIGS. 17-18, the second layer 602 of the second composite material forms at least part of the radially outer tire engaging portion 202 of the composite rim 600. The second layer 602 of the second composite material surrounds each opening of the plurality of openings 290. The second layer 602 of the second composite material includes three plies of strips. The three plies of strips consist of a first ply 602a, a second ply 602b, and a third ply 602c. The first ply 602a is the innermost ply. The first ply 602a is further from the outside surface of the rim 600 than the second ply 602b and the third ply 602c. The third ply 602c is the outermost ply. The third ply 602c forms at least a portion of the outer surface of the rim 600. The second ply 602b is located between the first ply 602a and the third ply 602c.

The example embodiment shown in FIGS. 17-18 depicts an overlapping construction of composite material plies. Generally, the rim 600 includes four overlapping joints 1000, 1100, 1010, 1110 that extend circumferentially around the rim. The joints 1000, 1100, 1010, 1110 are formed by the interconnection of two different materials. In the overlapping configuration, the joints form a stepped configuration. The two materials are inversely proportional in the stepped configuration. For example, as the first layer elongates the second layer recedes in the stepped configuration, and vise versa. This is made possible through the configuration shown in the embodiment. For example, the first ply 604a is longer than the second ply 604b. The second ply 604b is longer than the third ply 604c. The two first plies 607a, 608a are shorter than the two second plies 607b, 608b. The two second plies 607b, 608b are shorter than the two third plies 607c. 608c. The first ply 602a is longer than the second ply 602b. The second ply 602b is longer than the third ply 602c.

A first overlapping joint 1000 is now described. Specifically, the left end of the first ply 604a extends onto and sits on top of the end of the first ply 607a. The left end of the second ply 604b extends onto and sits on top of the end of the second ply 607b. The left end of the second ply 604b also aligns with the end of the first ply 607a. The left end of the third ply 604c sits on top of and next to the third ply 607c. The left end of the third ply 604c also aligns with the end of the second ply 607b.

A second overlapping joint 1100 is now described. The right end of the first ply 604a extends onto and sits on top of the end of the first ply 608a. The right end of the second ply 604b extends onto and sits on top of the end of the second ply 608b. The right end of the second ply 604b also aligns with the end of the first ply 608a. The right end of the third ply 604c sits on top of and next to the third ply 608c. The right end of the third ply 604c also aligns with the end of the second ply 608b.

For joints 1000 and 1100, the first ply 604a is further from the outside of the radially inner portion 204 of the rim 600 than the two first plies 607a, 608a. The first ply 604a is the innermost ply for joints 1000, 1100. The ends of the second ply 604b are further from the outside of the radially inner portion 204 of the rim 600 than the ends of the two second plies 607b, 608b where they overlap. The second ply 604b and the two first plies 607a, 608a are equidistant to the outside of the rim 600 at the point where they meet. The third ply 604c is further from the outside of the radially inner portion 204 of the rim 600 than the two third plies 607c. 608c where they overlap. The ends of the third ply 604c and the ends of the two third plies 607c, 608c are equidistant to the outside of the rim 600 at the point where they meet. The ends of the third ply 604c and the ends of the two third plies 607b, 608b are equidistant to the outside of the rim 600 at the point where they meet. All the plies of the two first plies 607, 608 cut off before the opening 280 and/or the center of the radially inner portion 204 of the rim 600. Therefore, the first layer 604 of the second composite material is the only layer surrounding opening 280 and/or the center of the radially inner portion 204 of the rim 600.

As can be seen in FIGS. 17 and 18, the plies 604a, to 604b, to 604c of the first layer 604 recede in length from 604a to 604c when viewed from top to bottom. In this case, the top is the ply closest to the tire engaging portion 202. The ply 604c having the shortest length. Thus, in the example, the first layer 604 depicts a receding stepped configuration at joints 1000 and 1100. Inversely, the plies 607a, 607b, 607c, 608a, 608b, and 608c of the first and second layers 607 and 608 of the first composite material elongate from 607a to 607c and 608a to 608c at joints 1000 and 1100. Thus, in the example, the first and second layers 607 and 608 have an elongating stepped configuration.

A third overlapping joint 1010 is now described. Specifically, the left end of the first ply 602a extends under and sits below the end of the first ply 607a. The left end of the second ply 602b extends under and sits below the end of the second ply 607b. The left end of the second ply 602b also aligns with the end of the first ply 607a. The left end of the third ply third ply 602c sits below and next to the end of the third ply 607c. The left end of the third ply 602c also aligns with the end of the second ply 607b.

A fourth overlapping joint 1110 is now described. The right end of the first ply 602a extends under and sits below the end of the first ply 608a. The right end of the second ply 602b extends under and sits below the end of the second ply 608b. The right end of the second ply 602b also aligns with the end of the first ply 608a. The right end of the third ply 602c sits below and next to the end of the third ply 608c. The right end of the third ply 602c also aligns with the end of the second ply 608b.

For joints 1010 and 1110, the first ply 602a is further from the outside of the radially outer tire engaging portion 202 of the rim 600 than the two first plies 607a, 608a where they overlap. The second ply 602b is further from the outside of the radially outer tire engaging portion 202 of the rim 600 than the two second plies 607b, 608b where they overlap. The second ply 602b and the two first plies 607a, 608a are equidistant to the outside of the rim 600 where they meet. The third ply 602c is further from the outside of the radially outer tire engaging portion 202 of the rim 600 than the two third plies 607c. 608c where they overlap. The ends of the third ply 602c and the ends of the two third plies 607c, 608c are equidistant to the outside of the rim 600 where they meet. The third ply 602c and the two second plies 607b, 608b are equidistant to the outside of the rim 600 where they meet. The plies 607, 608 cut off towards opening 290 and/or the center of the radially outer tire engaging portion 202 of the rim 600. Therefore, the second layer 602 of the second composite material is the only layer surrounding the opening 290 and/or the center of the radially outer tire engaging portion 202 of the rim 600.

As can be seen in FIGS. 17 and 18, the plies 602c, 602b, 602a of the second layer 602 elongate in length from 602c to 602a when viewed from top to bottom. In this case, the bottom is the ply closest to radially inner portion 204. The ply 602c has the shortest length. Thus, in the example, the second layer 602 depicts an elongating stepped configuration at joints 1010 and 1110. Inversely, plies of the first and second layers 607 and 608 of the first composite material recede at joints 1000 and 1100. The plies 607a, 607b, 607c, 608a, 608b, and 608c of the first and second layers 607 and 608 of the first composite material recede from 607c to 607a and 608c to 608a at joints 1010 and 1110. Third plies 607c, 608c, second plies 607b, 608b, and first plies 607a, 608a decrease in length in a stepped manner at joints 1010 and 1110. Thus, in the example, the first and second layers 607 and 608 have a receding stepped configuration.

In the embodiment shown in FIGS. 17-18, the first layer 604 of the second composite material extends circumferentially, such that the first layer 604 of the second composite material forms at least part of the radially inner portion 204 all the way around the composite rim 600. Further, the second layer 602 of the second composite material extends circumferentially, such that the second layer 602 of the second composite material forms at least part of the radially outer tire engaging portion 202 all of the way around the composite rim 600.

In an alternate embodiment, more than one layer of the second composite material may be used and each layer may consist of more or less than three plies. In a further alternate embodiment, more or less than two layers of the first composite material may be used and each layer may consist of more or less than three plies. In an alternate embodiment, the third composite material may be used instead of the first composite material.

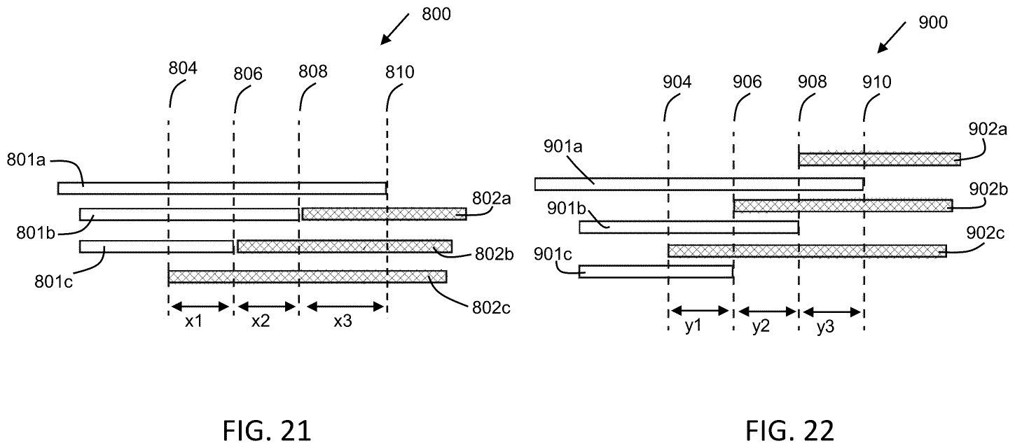

An example of an overlapping joint 800 can be seen in FIG. 21. In FIGS. 21. 802a, 802b, and 802c are first, second, and third plies of the first composite material, and 801a, 801b, and 801c, are first, second, and third plies of the second composite material, respectively. Ply 801a of the second composite material extends onto ply 802a of the first composite material by a distance X3. The distance X3 is a distance bound by dashed lines 808 and 810. Ply 801b extends onto ply 802b by a distance X2. The distance X2 is bounded by dashed lines 806 and 808. The ply 801b meets the ply 802a at dashed line 808. The ply 801c extends onto ply 802c by a distance X1. The distance X1 is bounded by the dashed lines 804 and 806. The ply 801c meets the ply 802b at dashed like 806. The distance X1, X2, and X3 are not the same. As disclosed in the figures, distance X3 is greater than distance X1 and X2. Distance X2 and X1 are the same. In an alternate embodiment, distance X1, X2, and X3 may be the same distance. In a further alternate embodiment, distances X1, X2, and X3 may all be different distances. In the figure, the first composite material 802 is shown as a elongating stepped configuration from 802a to 802c from top to bottom. Inversely, the second composite material is shown as having a receding stepped configuration from 801a to 801c at the joint 800 from top to bottom. In an alternate embodiment, more than one layer of each composite material may be used and each layer may consist of more or less than three plies.

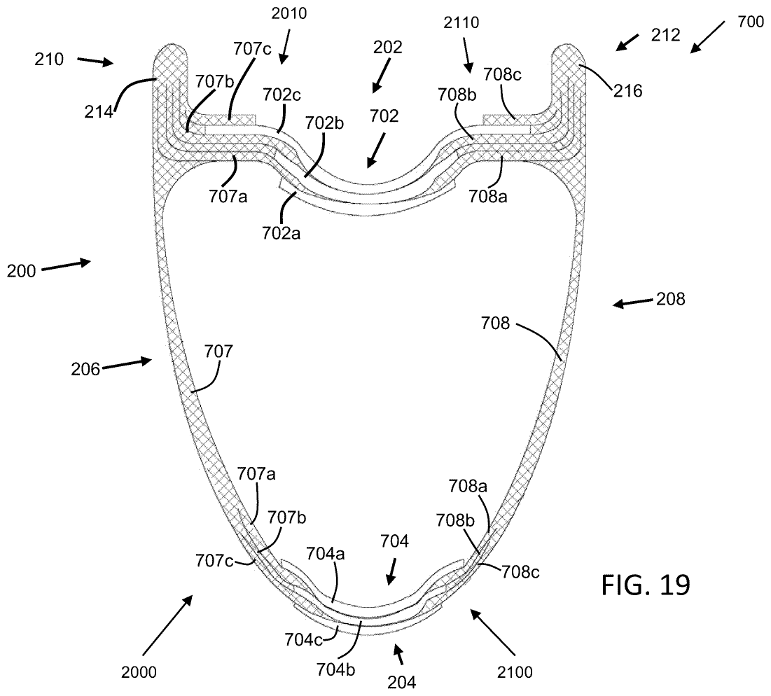

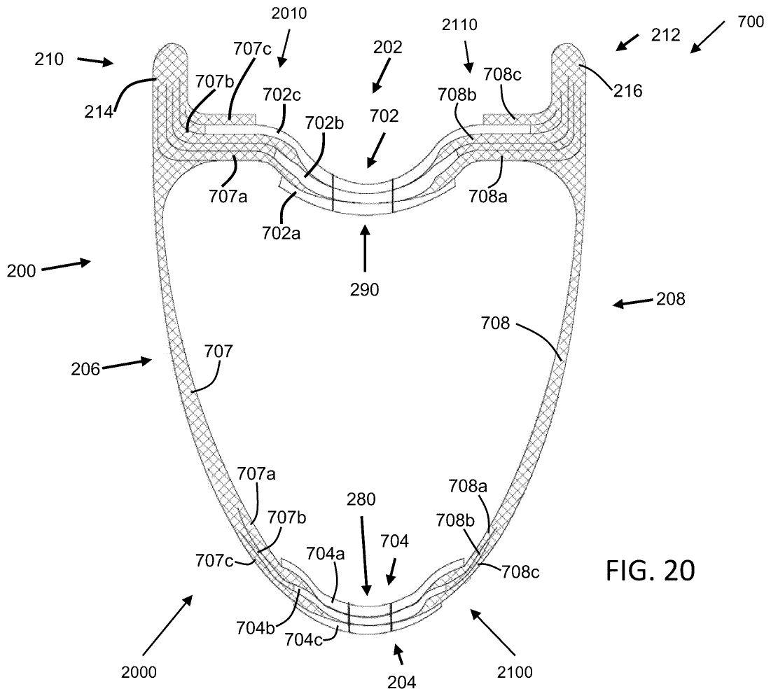

FIGS. 19-20 show an embodiment of a rim 700 depicting an interleaving pattern. For example, the rim 200 in the embodiment of FIGS. 3-7 may be constructed using this interleaving pattern. Specifically, a first layer 704 of the second composite material may be attached to a first layer 707 of the first composite material at an interleaving joint 2000. The first layer 704 of the second composite material may be attached to a second layer 708 of the first composite material at an interleaving joint 2100. A second layer 702 of the second composite material may be attached to the first layer 707 of the first composite material at an interleaving joint 2010. The second layer 702 of the second composite material may be attached to the second layer 708 of the first composite material at an interleaving joint 2110.

A first layer 704 of the second composite material forms at least part of the radially inner portion 204 of the composite rim 700. The first layer 704 of the second composite material surrounds each opening of the plurality of openings 280. The first layer 704 of the second composite material consists of three plies of strips. The three plies of strips include a first ply 704a, a second ply 704b, and a third ply 704c. The first ply 704a being the innermost ply. The first ply 704a is further from the outside of the rim 700 than the second ply 704b and the third ply 704c. The third ply 704c is the outermost ply. The third ply 704c forms at least a portion of the outer surface of the rim 700. The second ply 704b is located between the first ply 704a and the third ply 704c.

In the example embodiment, as shown in FIGS. 19-20, the two layers 707, 708 of the first composite material may form at least part of the first sidewall 206 and the second sidewall 208, respectively. The two layers 707, 708 of the first composite material may also form part of the radially outer tire engaging portion 202. For example, the first layer 707 of the first composite material may at least partially form the first tire retaining portion 210 (e.g., the first tire retaining wall 214). The second layer 708 of the first composite material may at least partially form the second tire retaining portion 212 (e.g., the second tire retaining wall 216).

The first layer 707 consists of three plies of strips. The plies of strips include a first ply 707a, a second ply 707b, and a third ply 707c. The first ply 707a is the innermost ply. The first ply 707a is further from the outside of the rim 700 than the second ply 707b and the third ply 707c. The third ply 707c is the outermost ply. The third ply 707c forms at least a portion of the outer surface of the rim 700. A second ply 707b is located between the first ply 707a and the third ply 707c.

The second layer 708 consists of three plies of strips. The plies of strips include a first ply 708a, a second ply 708b, and a third ply 708c. A first ply 708a is the innermost ply. The first ply 708a is further from the outside of the rim 700 than the second ply 708b and the third ply 708c. The third ply 708c is the outermost ply. The third ply 708c forms at least a portion of the outer surface of the rim 700. A second ply 708b is located between the first ply 708a and the third ply 708c.

In the example embodiment, as shown in FIGS. 19-20, a second layer 702 of the second composite material forms at least part of the radially outer tire engaging portion 202 of the composite rim 700. The second layer 702 of the second composite material surrounds each opening of the plurality of openings 290. The second layer 702 of the second composite material consists of three plies of strips. The three plies of strips include a first ply 702a, a second ply 702b, and a third ply 702c. The first ply 702a is the innermost ply. The first ply 702a is further from the outside surface of the rim 700 than the second ply 702b and the third ply 702c. The third ply 702c is the outermost ply. The third ply 702c forms at least a portion of the outer surface of the rim 700. The second ply 702b is located between the first ply 702a and the third ply 702c.

The example embodiment shown in FIGS. 19-20 depicts an interleaving construction of composite material plies. Generally, the rim 700 includes four interleaving joints 2000, 2100, 2010, 2110 that extend circumferentially around the rim. The joints 2000, 2100, 2010, 2110 are formed by two different materials that interleave. The joints 2000, 2100, 2010, 2110 may be stepped in configuration. The joints 2000, 2100, 2010, 2110 depict a tapering of the first composite material. Further, the joints 2000, 2100, 2010, 2110 depict the second composite material starting off in a splayed configuration. In the splayed configuration, the first composite material is thicker and sandwiched between the second composite material, spacing out the second composite material. The second composite material's spacing narrows as the first composite material tapers. This is made possible through the configuration shown in the embodiment. For example, the first ply 704a is longer than the second ply 704b. The second ply 704b is longer than the third ply 704c. The two first plies 707a, 708a are longer than the two second plies 707b. 708b. The two second plies 707b, 708b are longer than the two third plies 707c. 708c on the radially outer tire engaging portion 202 of the rim 700, and the two second plies 707b, 708b are shorter than the two third plies 707c. 708c on the radially inner portion 204 of the rim 700. The first ply 702a is shorter than the second ply 702b. The second ply 702b is shorter than the third ply 702c.

The first interleaving joint 2000 is described herein. Specifically, the left end of the first ply 704a extends onto and sits on top of the end of the first ply 707a. The left end of the second ply 704b is located between the first ply 707a and the third ply 707c of the first composite material. Additionally, the left end of the second ply 704b aligns with the end of the second ply 707b. The left end of the second ply 704b extends onto and sits on top of the end of the third ply 707c. The left end of the third ply 704c extends under and sits below the end of the third ply 707c.

The second interleaving joint 2100 is described herein. The right end of the first ply 704a extends onto and sits on top of the end of the first ply 708a. The right end of the second ply 704b is located between the first ply 708a and third ply 708c of the first composite material. The right end of the second ply 704b aligns with the end of the second ply 708b. The right end of the second ply 704b extends onto and sits on top of the end of the third ply 708c. The right end of the third ply 704c extends under and sits below the end of the third ply 708c.

For joints 2000 and 2100, the first ply 704a is further from the outside of the radially inner portion 204 of the rim 700 than the two first plies 707a. 708a where they overlap. The ends of the two first plies 707a, 708a are located between the ends of the first ply 704a and the second ply 704b. The ends of the two third plies 707c, 708c are located between the ends of the second ply 704b and 704c. The ends of the second ply 704b and the ends of the two second plies 707b, 708b are equidistant to the outside of the rim 700 where they meet. The second ply 704b is further from the outside of the radially inner portion 204 of the rim 700 than the third plies 707c. 708c where they overlap. The third ply 704c is closer to the outside of the radially inner portion 204 of the rim 700 than the two third plies 707c. 708c where they overlap.

The plies (e.g., 707a, 707b, 707c, 708a, 708b, and 708c) of the first and second layer of the first composite material 707, 708 taper off and gradually decrease in thickness as they move towards opening 280 and/or the center of the radially inner portion 204 of the rim 700. Therefore, the first layer 704 of the second composite material is the only layer surrounding the opening 280 and/or the center of the radially inner portion 204 of the rim 700.

In the example, the ends of the plies 704a, 704b, and 704c of the first layer 704 of the second composite material are splayed. As plies 704a, 704b, and 704c move towards the inner portion 204, plies 704a, 704b, and 704c narrow inwards. The rate of narrowing may correlate with the rate of tapering of the first and second layers 707, 708 of the first composite material, and/or with a desired shape of the rim 700. The first layer 704 is most compressed at the center of the radially inner portion 204 where none of the first composite material is present.

A third overlapping joint 2010 is now described. The left end of the first ply 702a extends under and sits below the end of the first ply 707a. The left end of the second ply 702b is located between the first ply 707a and the second ply 707b of the first composite material. The left end of the second ply 702b extends under and sits below the end of the second ply 707b. The left end of the third ply 702c is located between the second ply 707b and the third ply 707c of the first composite material. The left end of the third ply 702c extends under and sits below the end of third ply 707c.

A fourth overlapping joint 2110 is now described. The right end of the first ply 702a extends under and sits below the end of the first ply 708a. The right end of the second ply 702b is located between the first ply 708a and the second ply 708b of the first composite material. The right end of the second ply 702b extends under and sits below the end of the second ply 708b. The right end of third ply 702c is located between the second ply 708b and the third ply 708c of the first composite material. The right end of the third ply 702c extends under and sits below the end of the third ply 708c.

For joints 2010 and 2110, the first ply 702a is further from the outside of the radially outer tire engaging portion 202 of the rim 700 than the two first plies 707a, 708a where they overlap. The ends of the two first plies 707a. 708a are located between the ends of the first ply 702a and the second ply 702b. The ends of the two second plies 707b, 708b are located between the ends of the third ply 702c and the second ply 702b. The second ply 702b is further from the outside of the radially outer tire engaging portion 202 of the rim 700 than the two second plies 707b. 708b where they overlap. The third ply 702c is further from the outside of the radially outer tire engaging portion 202 of the rim 700 than the two third plies 707c. 708c where they overlap.

The plies (e.g., 707a, 707b, 707c, 708a, 708b, and 708c) of the first and second layer of the first composite material 707, 708 taper off and gradually decrease in thickness as they move towards the opening 290 and/or the center of the radially outer tire engaging portion 202 of the rim 700. Therefore, the second layer 702 of the second composite material is the only layer surrounding the opening 290 and/or the center of the radially outer tire engaging portion 202 of the rim 700.

In the example, the ends of the plies 702a, 702b, and 702c of the second layer 702 of the second composite material are splayed. As plies 702a. 702b, and 702c move towards the center of the engaging portion 202, plies 702a, 702b, and 702c narrow inwards. The rate of narrowing may correlate with the rate of tapering of the first and second layers 707, 708 of the first composite material, and/or with a desired shape of the rim 700. The second layer 702 is most compressed at the center of the radially engaging portion 202 where none of the first composite material is present.

In the embodiment shown in FIGS. 19-20, the first layer 704 of the second composite material extends circumferentially, such that the first layer 704 of the second composite material forms at least part of the radially inner portion 204 all the way around the composite rim 700. Further, the second layer 702 of the second composite material extends circumferentially, such that the second layer 702 of the second composite material forms at least part of the radially outer tire engaging portion 202 all of the way around the composite rim 700.

In an alternate embodiment, more than one layer of the second composite material may be used and each layer may consist of more or less than three plies. In a further alternate embodiment, more or less than two layers of the first composite material may be used and each layer may consist of more or less than three plies. In an alternate embodiment, the third composite material may be used instead of the first composite material.

An example of an interleaving joint 900 can be seen in FIG. 22. In FIGS. 22, 902a, 902b, and 902c are first, second, and third plies of the first composite material, and 901a, 901b, and 901c, are first, second, and third plies of the second composite material, respectively. Ply 901a of the second composite material extends between plies 902a and 902b of the first composite material. Ply 901a extends below ply 902a by a distance Y3. The distance Y3 is bounded by dashed lines 910 and 908. The ply 901a extends onto and above ply 902b of the second composite material by a distance of Y2 plus Y3 (Y2+Y3). Y2 is bounded by dashed lines 906 and 908. Thus, the total extension of ply 901a onto and/or over ply 902b is between dashed lines 906 and 910.

Ply 901b of the second composite material extends between plies 902b and 902c of the first composite material. Ply 901b extends below ply 902b by a distance Y2. Ply 901b extends onto and above ply 902c by a distance of Y1 plus Y2 (Y1+Y2). The distance Y1 is bounded by dashed lines 904 and 906. Thus, the total extension of ply 901b onto and/or over ply 902c is bounded between dashed lines 904 to 908.

Ply 901c of the second composite material is located below ply 902c by a distance of Y1. In the embodiment, and as disclosed in the figures, distances Y1, Y2 and Y3 are equal distances. In an alternate embodiment, Y1, Y2 and Y3 are not equal distances.

Further, in the embodiment shown, the first composite material 902 is shown as a elongating stepped configuration from 902a to 902c from top to bottom. Inversely, the second composite material 901 is shown as having a receding stepped configuration from 901a to 901c at the joint 900 from top to bottom. In an alternate embodiment, more than one layer of each composite material may be used and each layer may consist of more or less than three plies.

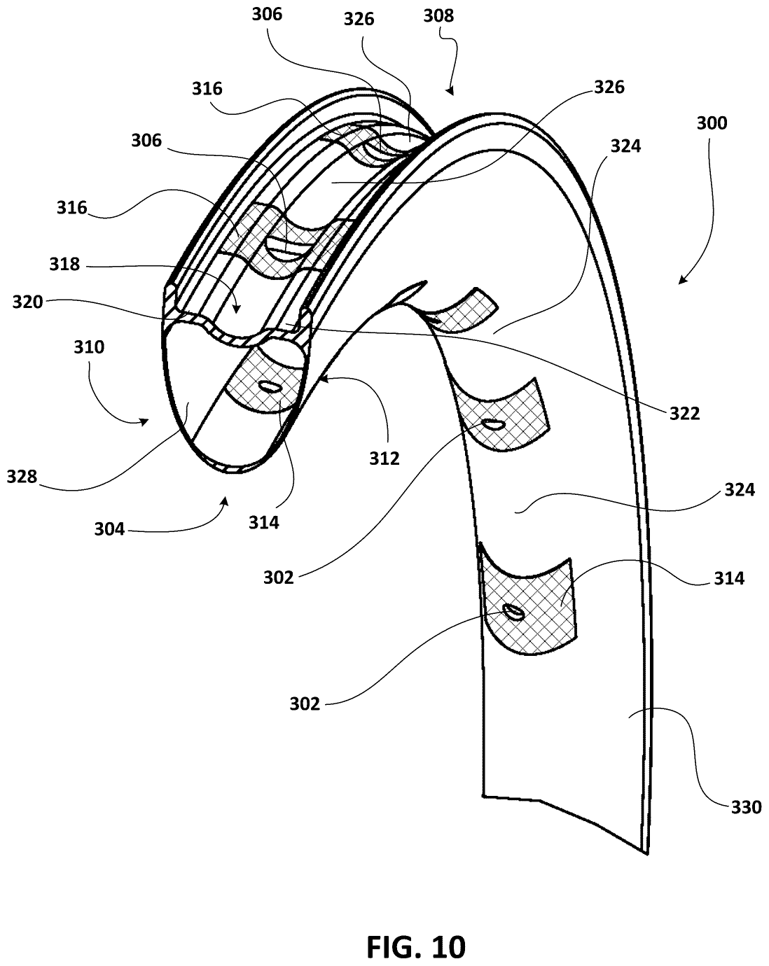

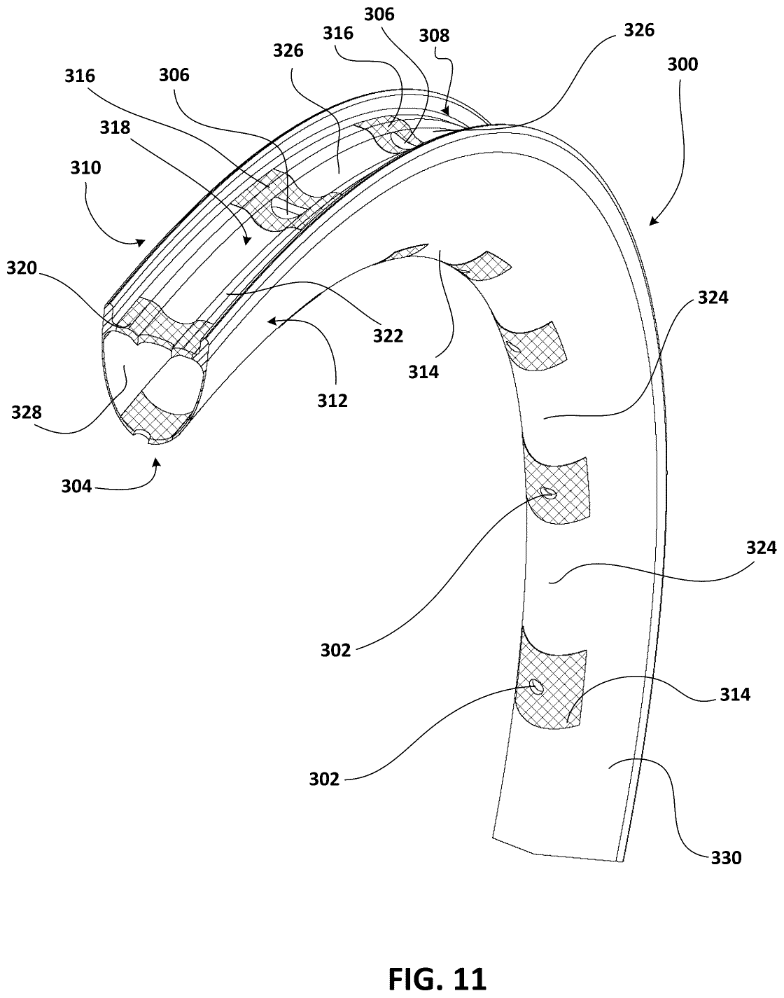

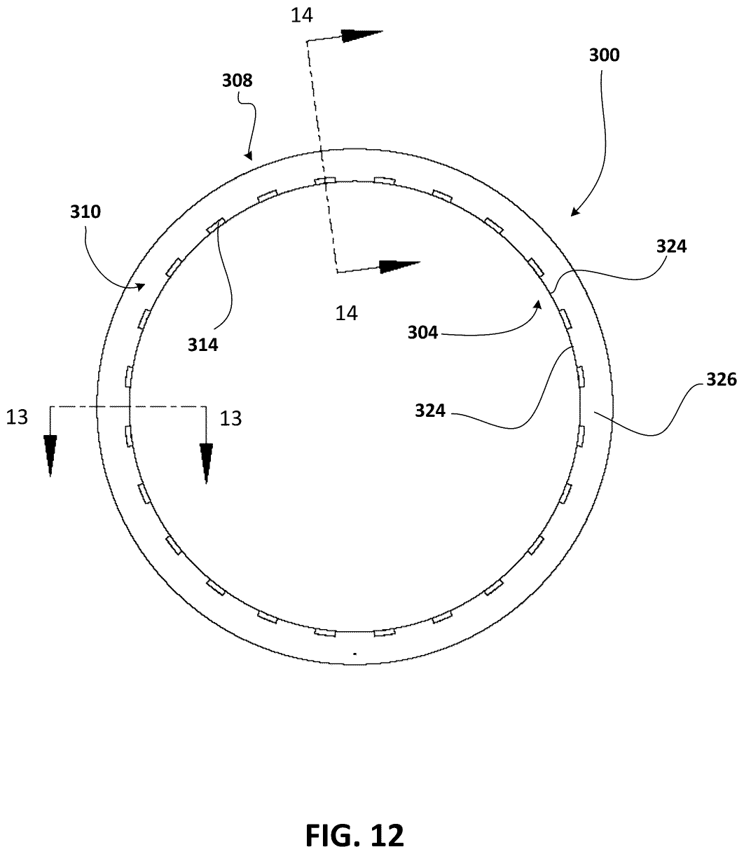

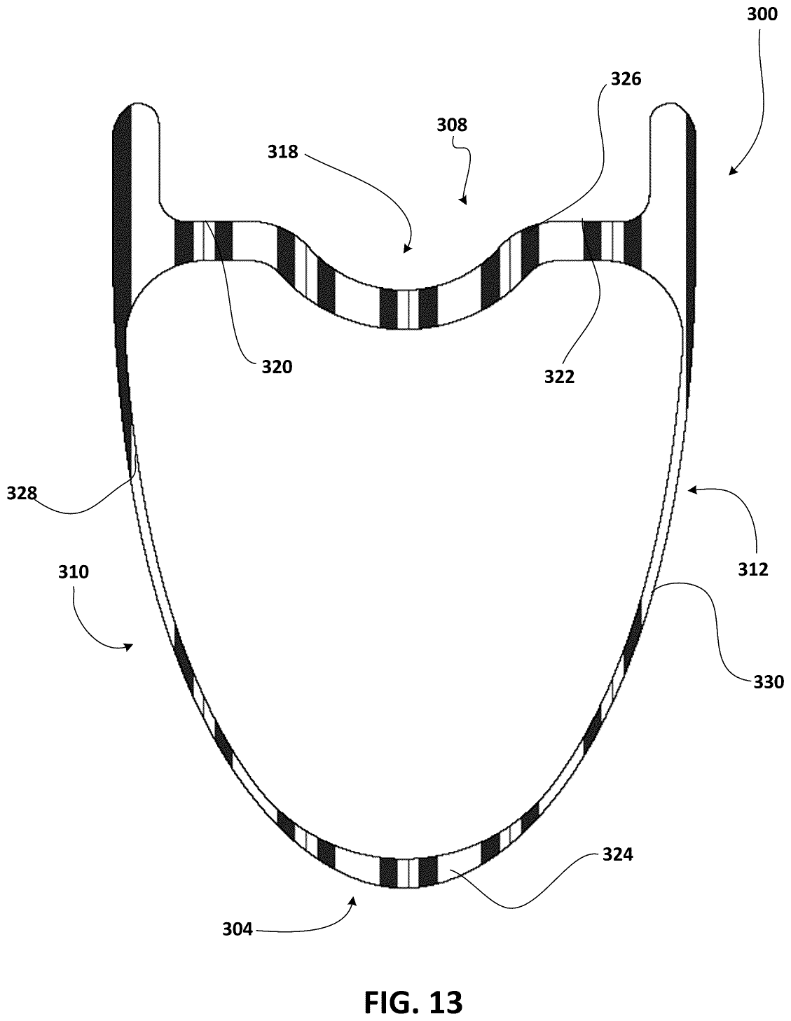

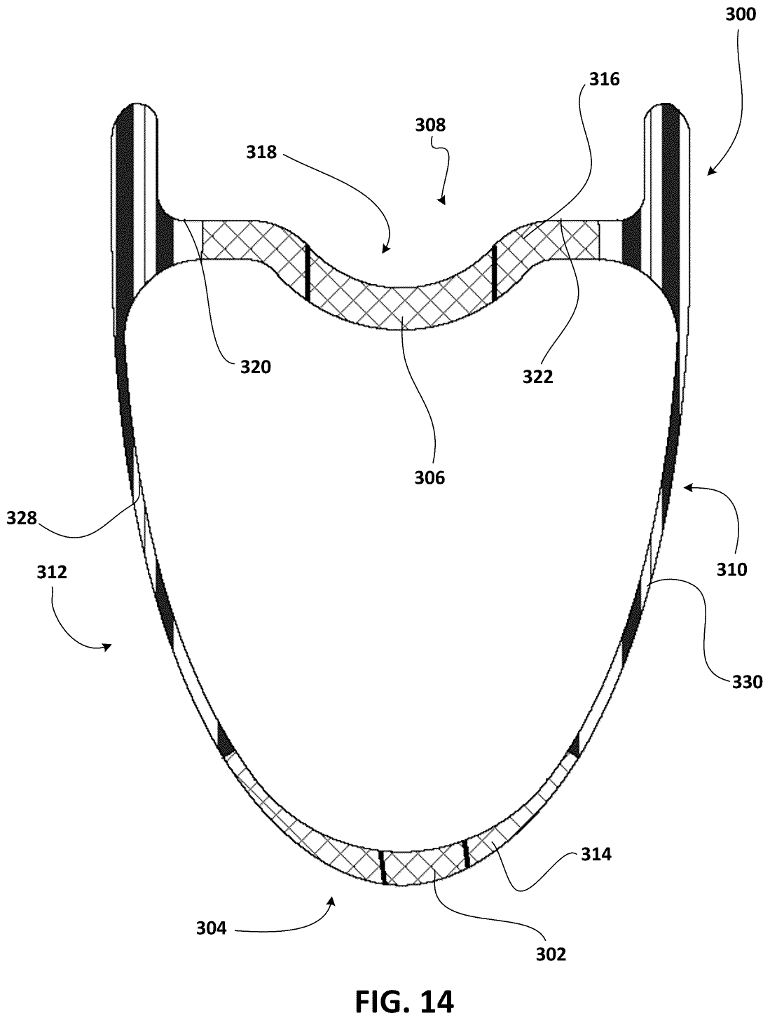

As an example of another configuration, FIGS. 10-14 show a second embodiment of a composite rim 300 formed by layers of multiple composite materials. The composite rim 300 again includes a plurality of openings 302 (e.g., spoke holes) that extend through a radially inner portion 304 of the composite rim 300, and a plurality of openings 306 (e.g., access holes) that extend through a radially outer tire engaging portion 308. A first sidewall 310 and a second sidewall 312 are spaced apart from each other and extend between the radially inner portion 304 and the radially outer tire engaging portion 308.

The spoke holes 302 and the access holes 306 are surrounded by the second composite material. Instead of at least one first layer of the second composite material extending all the way around the composite rim 300 and forming at least part of the radially inner portion 304, as shown in the first embodiment of FIGS. 3-7, the composite laminate of the composite rim 300 includes a plurality of first layers 314 of the second composite material at the plurality of openings 302 (e.g., the spoke holes), respectively, and a plurality of second layers 316 of the second composite material at the plurality of openings 306 (e.g., the access holes). In other words, the plurality of first layers 314 of the second composite material act as first patches that surround the spoke holes 302 (e.g., without the first composite material or the third composite material surrounding the holes 302), and the plurality of second layers 316 of the second composite material act as second patches that surround the access holes 306 (e.g., without the first composite material or the third composite material surrounding the access holes 306).

The first patches 314 may be any number of different shapes and/or sizes. For example, the first patches 314 may be square-shaped or rectangular (e.g., prior to curing). A width of the first patches 314 may correspond to a width of the radially inner portion 304 of the composite rim 300. In one embodiment, the width of the first patches 314 may be less than the width of the radially inner portion 304 of the composite rim 300. A length of the first patches 314 may be the same as, less than, or greater than the width of the first patches 314.

The second patches 316 may be any number of different shapes and/or sizes. For example, the second patches 316 may be square-shaped or rectangular (e.g., prior to curing). A width of the second patches 316 may correspond to a width of a portion of the radially outer tire engaging portion 308 (e.g., a well 318, a first shelf 320, and a second shelf 322 of the radially outer tire engaging portion 308) of the composite rim 300. In one embodiment, the width of the second patches 316 may be less than the width of the portion of the radially outer tire engaging portion 308 (e.g., may correspond to a width of only the well 318) of the composite rim 300. A length of the second patches 316 may be the same as, less than, or greater than the width of the second patches 316.

In one embodiment, a remainder of the composite rim 300 is formed by at least one layer of the first composite material. For example, first layers 324 of the first composite material are disposed between adjacent pairs of the first patches 314, respectively, and form part (e.g., a remainder) of the radially inner portion 304 of the composite rim 300. Second layers 326 of the first composite material are disposed between adjacent pairs of the second patches 316, respectively, and form part (e.g., a remainder) of the radially outer tire engaging portion 308 of the composite rim 300. One or more third layers 328 of the first composite material form the first sidewall 310, which extends between the radially inner portion 304 and the radially outer tire engaging portion 308 of the composite rim 300, and one or more fourth layers 330 of the first composite material form the second sidewall 312, which extends between the radially inner portion 304 and the radially outer tire engaging portion 308 of the composite rim 300. The composite rim 300 may include more, fewer, and/or different layers, and/or may include more and/or different composite materials (e.g., the third composite material).

The composite layers that make up the embodiment shown in FIGS. 10-14, can be configured in the same way depicted in FIGS. 17-22. The plies of each layer can be configured in an overlapping pattern (see FIGS. 17-18) or an interleaving pattern (see FIGS. 19-20). When applying the interleaving or overlapping patterns of FIGS. 17-22 to the embodiment shown in FIGS. 10-14, the layers may not extend all the way around the rim like they do in FIGS. 17-20, but may exist only locally where the patches are, in accordance with FIGS. 10-14. Other patterns known by those of skill in the art may be used to form the composite rim 300.

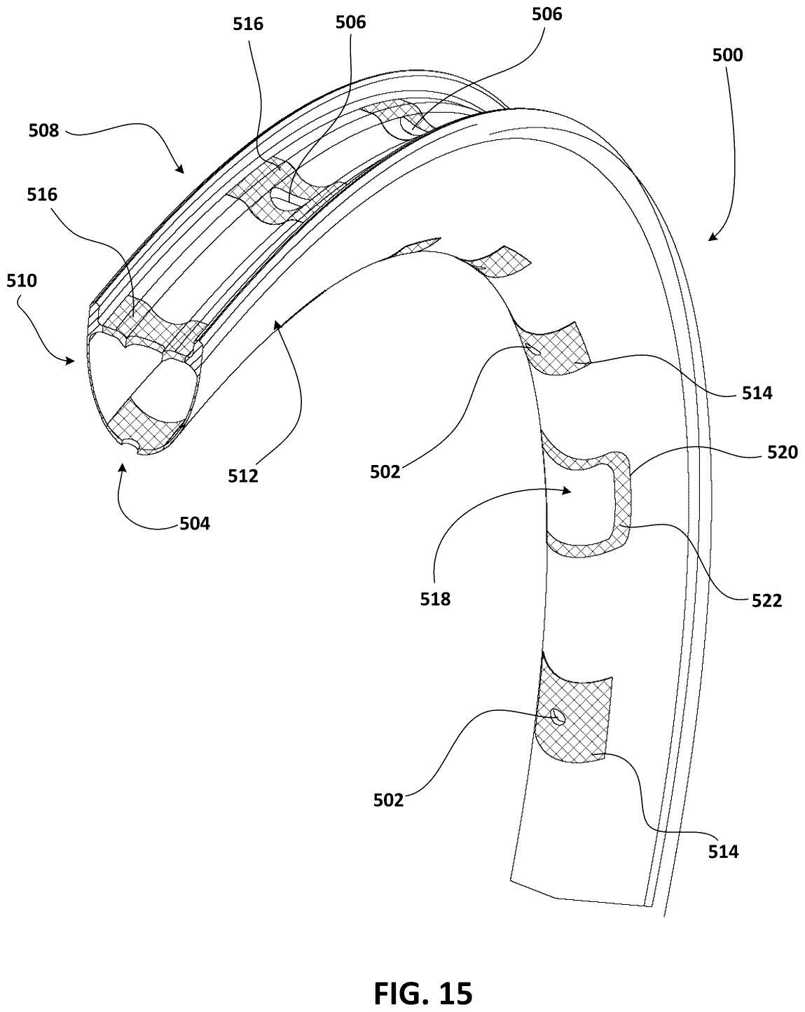

As yet another example of a configuration, FIG. 15 shows a third embodiment of a composite rim 500 formed by layers of multiple composite materials. The composite rim 500 again includes a plurality of openings 502 (e.g., spoke holes) that extend through a radially inner portion 504 of the composite rim 500, and a plurality of openings 506 (e.g., access holes) that extend through a radially outer tire engaging portion 508. A first sidewall 510 and a second sidewall 512 are spaced apart from each other and extend between the radially inner portion 504 and the radially outer tire engaging portion 508.

The composite rim 500 of the third embodiment shown in FIG. 15 is similar to the composite rim 300 of the second embodiment shown in FIGS. 10-14. For example, the composite laminate of the composite rim 500 includes first patches 514 of the second composite material that form part of the radially inner portion 504 of the composite rim 500, and includes second patches 516 of the second composite material that form part of the radially outer tire engaging portion 508 of the composite rim 500. The spoke holes 502 extend through the first patches 514, respectively, and the access holes 506 extend through the second patches 516, respectively.

The composite rim 500 also includes an opening 518 that forms a recess in which a device (e.g., an electronic device such as a sensor device) of a bicycle is positionable and attachable to the composite rim 500. The opening 518 may be any number of shapes and/or sizes. For example, the opening 518 may be shaped and sized to correspond to a shape and a size of the electronic device to be positioned within the opening 518. The opening 518 may be larger than the spoke holes 502 and the access holes 506.

The composite laminate of the composite rim 500 further includes a third layer 520 of the second composite material (e.g., a third patch), and the opening 518 extends through the third patch 520. The third patch 520 may be larger (e.g., have a larger width and/or length) than the first patches 514 and the second patches 516 to accommodate the larger opening 518. The formation (e.g., cutting) of the opening 518 through the third patch 520 may leave a border 522 of the second composite material around the opening 518, such that the second composite material surrounds the opening 518. The border 522 of the second composite material may seal the opening 518, such that moisture degradation is reduced or prevented.

Composite materials may require deflashing or removal of unwanted resin from a molding process. The process may expose fibers (e.g., fibers of the first composite material). In one embodiment, an inherently sealed material (e.g., the second composite material, fiberglass) may be used locally to seal the composite laminate at the opening 518 (e.g., forming the border 522).

The composite layers that make up the embodiment shown in FIG. 15, can be configured in the same way depicted in FIGS. 17-22. The plies of each layer can be configured in an overlapping pattern (see FIGS. 17-18) or an interleaving pattern (see FIGS. 19-20). When applying the interleaving or overlapping patterns of FIGS. 17-22 to the embodiment shown in FIG. 15, the layers may not extend all the way around the rim like they do in FIGS. 17-20, but may exist only locally where the patches are, in accordance with FIG. 15. Other patterns known by those of skill in the art may be used to form the composite rim 500.

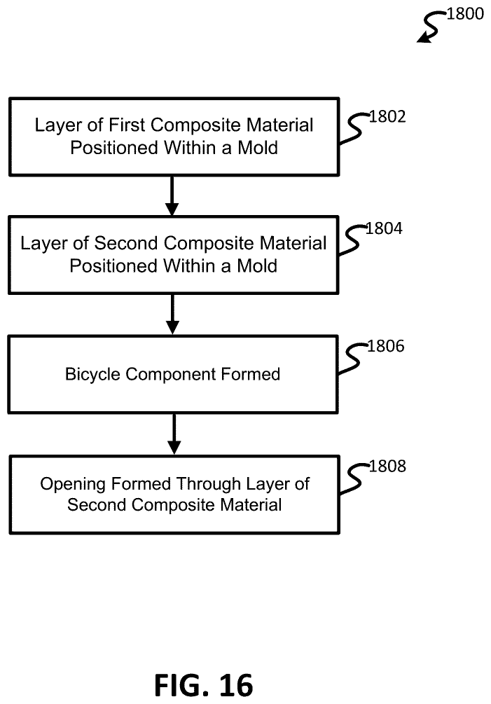

FIG. 16 illustrates a method 1800 for manufacturing a bicycle component (e.g., the rim 122) of a bicycle (e.g., the bicycle 50). The acts of the method 1800 presented below are intended to be illustrative. In some embodiments, the method 1800 may be accomplished with one or more additional acts not described, and/or without one or more of the acts described. Additionally, the order in which the acts of the method 1800 are illustrated in FIG. 16 and described below is not intended to be limiting.

In act 1802, at least one layer (e.g., a layer) of a first composite material is positioned within a mold. The first composite material includes a matrix of a first polymer-based material and natural fibers of a first reinforcing material. In one embodiment, fiber orientation of the natural fibers of the first reinforcing material of the layer of the first composite material is unidirectional in a direction along a length of the respective layer.

The layer of the first composite material may be any number of shapes and/or sizes. For example, the layer of the first composite material may be rectangular in shape and may have a width at least as large as a height of a sidewall of a rim to be manufactured. Other shapes and/or sizes may be provided.

The first polymer-based material may be or include any number of polymer-based materials including, for example, a thermoplastic, a thermoset matrix, or a combination thereof. The fibers of the first reinforcing material may be or include any number of different types of natural fibers including, for example, flax fibers, kenaf fibers, hemp fibers, jute fibers, sisal fibers, or any combination thereof. Other polymer-based materials and/or other reinforcing materials may be used for the first composite material.

In one embodiment, the layer of the first composite material is positioned within the mold, such that the layer of the first composite material forms at least part of one of two sidewalls of the rim to be manufactured. In other embodiments, the layer of the first composite material is positioned within the mold, such that the layer of the first composite material forms at least part of another portion of the rim to be manufactured (e.g., a radially inner portion of the rim to be manufactured).

In act 1804, at least one layer (e.g., a layer) of a second composite material is positioned within the mold, such that the layer of the second composite material abuts the layer of the first composite material. The second composite material includes a matrix of a second polymer-based material and fibers of a second reinforcing material. The second polymer-based material may be or include any number of polymer-based materials including, for example, a plastic, an acrylic, a resin, an epoxy, or any combination thereof. The fibers of the second reinforcing material may be or include any number of different types of fibers including, for example, carbon fibers. The second composite material may have a lower porosity than the first composite material. Other polymer-based materials and/or other reinforcing materials may be used for the second composite material.

The layer of the second composite material may be any number of shapes and/or sizes. For example, the layer of the second composite material may be rectangular in shape and may have a width at least as large as a width of the radially inner portion of a rim to be manufactured. Other shapes and/or sizes may be provided. In one embodiment, the layer of the second composite material is thicker than the layer of the first composite material. In another embodiment, the layer of the second composite material is thinner than the layer of the first composite material.

In one embodiment, the layer of the second composite material is positioned within the mold, such that the layer of the second composite material forms at least part of the radially inner portion of the rim to be manufactured. In other embodiments, the layer of the second composite material is positioned within the mold, such that the layer of the second composite material forms at least part of another portion of the rim to be manufactured (e.g., a radially outer tire engaging portion).

Acts 1802 and 1804 may be repeated any number of times to form a layup pattern for the bicycle component. In one embodiment, acts 1802 and 1804 may be repeated with one or more additional acts, in which one or more layers of other composite materials are positioned any number of times to, for example, form a layup pattern.

In one embodiment, act 1802 is repeated, and another layer of the first composite material is positioned within the mold, such that the other layer of the first composite material forms at least part of the other of the two sidewalls of the rim to be manufactured. Act 1804 is also repeated, and another layer of the second composite material is positioned within the mold, such that the other layer of the second composite material forms at least part of the radially outer tire engaging portion of the rim to be manufactured.

In another embodiment, act 1804 is repeated, and another layer of the second composite material is positioned within the mold, such that the other layer of the second composite material also abuts (e.g., overlaps) the layer of the first composite material. For example, the layer of the first composite material is disposed between the layer of the second composite material and the other layer of the second composite material (e.g., the layer of the first composite material abuts the layer of the second composite material and the other layer of the second composite material on opposite sides of the layer of the first composite material), and the layer of the first composite material, the layer of the second composite material, and the other layer of the second composite material form part of the radially inner portion or the radially outer tire engaging portion of the rim to be manufactured. Acts 1802 and 1804 may be repeated around the inner circumference and/or the outer circumference of the rim to be manufactured, for example, to form a layup pattern corresponding to the composite laminate shown in, for example, the second embodiment of FIGS. 10-14.

The layup pattern, once formed into a composite laminate, may correspond to the composite laminate shown in the first embodiment of FIGS. 3-7, the second embodiment of FIGS. 10-14, the third embodiment of FIG. 15, or another composite laminate.

In act 1806, the bicycle component is formed. Forming the bicycle component includes forming a composite laminate (e.g., lamination) that includes at least the layer of the first composite material and the layer of the second composite material within the mold. In one embodiment, forming the bicycle component includes forming the composite laminate that includes at least the layer of the first composite material, the layer of the second composite material, and the layer of the third composite material within the mold.

The mold may be used to form all or part of the bicycle component. For example, for a rim, the mold may be broken up into multiple parts to allow access to the mold when positioning at least the layer of the first material in act 1802 and the layer of the second material in act 1804. For example, the mold may be broken up into multiple circumferential portions (e.g., four circumferential portions) and/or multiple pieces (e.g., a first sidewall piece, a second sidewall piece, and a radially outer piece).

Forming the composite laminate may include shaping and curing the composite laminate within, for example, the mold. For example, at least the layer of the first composite material and the layer of the second composite material may be positioned within the mold and shaped using a bladder inflated within the mold. The composite laminate may be shaped in other ways.

Once shaped, the composite laminate may be cured in any number of ways including, for example, by press curing, autoclave curing, or oven curing the composite laminate that includes at least the layer of the first composite material and the layer of the second composite material. Other types of curing may be used.

In act 1808, an opening is formed through the layer of the second composite material of the composite laminate, such that the second composite material surrounds the opening (e.g., without the first composite material surrounding the opening). The opening may be formed through the layer of the second composite material of the composite laminate in any number of ways including, for example, by drilling the opening through the layer of the second composite material. The opening may be formed through the layer of the second composite material in any number of other ways. For example, the opening may be formed through the layer of the second composite material by cutting the opening out of the layer of the second composite material. The opening may be any number of different types of openings including, for example, a spoke hole, a valve hole, an access hole, a recess in which a device (e.g., an electronic device) for a bicycle may be positionable and attachable, or another type of opening.

Act 1808 may be repeated any number of times. For example, act 1808 may be repeated for the other layer of the second composite material (e.g., as another valve hole or an access hole) and any other layers of the second composite material through which an opening is to extend (e.g., for spoke holes or access holes).

In one embodiment, in which the layer of the second composite material extends all the way around the composite laminate of the rim to form at least part of the radially inner portion of the rim or the radially outer tire engaging portion of the rim, act 1808 may be repeated any number of times (e.g., 34 or 36 times), such that a plurality of openings (e.g., spoke holes or access holes) are formed through the layer of the second composite material.

The plurality of openings may be formed through the layer of the second composite material in any number of configurations. For example, the plurality of openings may be formed through the layer of the second composite material, such that the plurality of openings are distributed uniformly around the rim (e.g., around the radially inner portion of the rim). Other configurations of the plurality of openings may be provided.

The method 1800 may be used to manufacture any number of different bicycle components. For example, in addition to bicycle rims, the method 1800 may be used to manufacture crankarms, handlebars, stems, seat posts, seat rails, shifting levers, brake levers, derailleur cages, suspension fork components, and/or other bicycle components.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A rim for a bicycle wheel, the rim comprising:
a radially inner portion disposed along an inner circumference of the rim;
a first sidewall;
a second sidewall spaced apart from the first sidewall, wherein the first sidewall and the second sidewall extend radially outward from the radially inner portion; and
a radially outer tire engaging portion disposed along an outer circumference of the rim, the radially outer tire engaging portion extending from the first sidewall and the second sidewall, respectively;
an opening that extends through the radially inner portion, the first sidewall, the second sidewall, the radially outer tire engaging portion, or any combination thereof,
wherein the first sidewall, the second sidewall, the radially outer tire engaging portion, the radially inner portion, or any combination thereof includes a composite laminate, the composite laminate including one or more compressed layers of a first composite material and one or more compressed layers of a second composite material, the second composite material being different than the first composite material and having a lower porosity compared to the first composite material,
wherein the first composite material includes a matrix of a polymer-based material and natural fibers for a reinforcing material, and
wherein the opening extends through at least one layer of the one or more compressed layers of the second composite material, such that the second composite material surrounds the opening.

2. The rim of claim 1, wherein the polymer-based material is a thermoplastic, a thermoset matrix, or a combination thereof, and
wherein the natural fibers of the reinforcing material are flax fibers.

3. The rim of claim 2, wherein the polymer-based material is a first polymer-based material, and the reinforcing material is a first reinforcing material,
wherein the second composite material includes a matrix of a second polymer-based material and fibers for a second reinforcing material,
wherein the second polymer-based material is a plastic, an acrylic, a resin, an epoxy, or any combination thereof, and
wherein the fibers of the second reinforcing material are carbon fibers.

4. The rim of claim 1, wherein the opening is a first opening that extends through the radially inner portion,
wherein the rim further comprises a second opening that extends through the radially outer tire engaging portion,
wherein the at least one layer of the second composite material is at least one first layer of the second composite material, and
wherein the second opening extends through at least one second layer of the one or more compressed layers of the second composite material, such that the second composite material surrounds the second opening.

5. The rim of claim 4, wherein the first opening is a spoke hole, a valve hole, or an opening in which an electronic component of the bicycle is supportable, and wherein the second opening is an access hole.

6. The rim of claim 4, wherein the at least one first layer of the second composite material forms at least part of the radially inner portion, the part of the radially inner portion extending all of the way around the radially inner portion.

7. The rim of claim 6, wherein the at least one second layer of the second composite material forms at least part of the radially outer tire engaging portion, the part of the radially outer tire engaging portion extending all of the way around the radially outer tire engaging portion.

8. The rim of claim 1, wherein the opening is a first opening that extends through the radially inner portion, and
wherein the rim further comprises a second opening that extends through the radially inner portion, the second opening being at a distance away from first opening along the radially inner portion.

9. The rim of claim 8, wherein the at least one layer of the second composite material is at least one first layer of the second composite material, and
wherein the second opening extends through at least one second layer of the one or more compressed layers of the second composite material, such that the second composite material surrounds the second opening.

10. The rim of claim 9, wherein at least one layer of the one or more compressed layers of the first composite material partially forms the radially inner portion, the at least one layer of the first composite material being disposed between the at least one first layer of the second composite material and the at least one second layer of the second composite material.

11. The rim of claim 8, wherein the first opening and the second opening are spoke holes, respectively.

12. A method of manufacturing a bicycle component, the method comprising:
positioning a layer of a first composite material within a mold, the first composite material including natural fibers of a first reinforcing material;
positioning a layer of a second composite material within the mold, such that a portion of the layer of the second composite material abuts, overlaps, or abuts and overlaps the layer of the first composite material, the second composite material including fibers of a second reinforcing material, the second reinforcing material being different than the first reinforcing material and having a lower porosity compared to the first composite material;
forming the bicycle component, forming the bicycle component comprising forming a composite laminate that includes the layer of the first composite material and the layer of the second composite material within the mold; and
forming an opening through the layer of the second composite material of the composite laminate, such that the second composite material surrounds the opening.

13. The method of claim 12, wherein the natural fibers of the first reinforcing material are flax fibers, and
wherein the fibers of the second reinforcing material are carbon fibers.

14. The method of claim 12, wherein forming the opening through the layer of the second composite material of the composite laminate comprises drilling the opening through the layer of the second composite material of the composite laminate.

15. The method of claim 12, wherein the layer of the first composite material and the layer of the second composite material form portions of a radially inner portion of the rim or a radially outer tire engaging portion of the rim, respectively.

16. The method of claim 15, wherein the layer of the second composite material is a first layer of the second composite material, and the opening is a first opening,
wherein the method further comprises:
positioning a second layer of the second composite material within the mold, such that a portion of the second layer of the second composite material abuts, overlaps, or abuts and overlaps the layer of the first composite material and the layer of the first composite material is between the first layer of the second composite material and the second layer of the second composite material; and
forming a second opening through the composite laminate, the forming of the second opening comprising forming the second opening through the second layer of the second composite material of the composite laminate, such that the second composite material surrounds the second opening.

17. The method of claim 12, wherein the bicycle component is a rim, and
wherein the layer of the second composite material extends all of the way around the rim and forms at least part of a radially inner portion disposed along an inner circumference of the rim, or at least part of a radially outer tire engaging portion disposed along an outer circumference of the rim.

18. The method of claim 17, wherein the layer of the second composite material is a first layer of the second composite material and forms at least part of the radially inner portion of the rim,
wherein the method further comprises positioning a second layer of the second composite material within the mold, such that the layer of the first composite material is between the first layer of the second composite material and the second layer of the second composite material, and
wherein the second layer of the second composite material forms at least part of the radially outer tire engaging portion.

19. The method of claim 18, wherein the layer of the first composite material forms at least part of a sidewall of the rim.

20. A rim for a bicycle wheel, the rim comprising:
a radially inner portion disposed along an inner circumference of the rim;
a first sidewall;
a second sidewall spaced apart from the first sidewall, wherein the first sidewall and the second sidewall extend radially outward from the radially inner portion; and
a radially outer tire engaging portion disposed along an outer circumference of the rim, the radially outer tire engaging portion extending from the first sidewall and the second sidewall, respectively;
a number of openings that extend through the radially inner portion, the number of openings being spoke holes and being spaced apart from each other around the radially inner portion,
wherein at least the radially inner portion includes a composite laminate, the composite laminate including one or more compressed layers of a first composite material and one or more compressed layers of a second composite material, the second composite material being different than the first composite material and having a lower porosity compared to the first composite material,
wherein the compressed layers of the first composite material and the second composite material each consist of plies of strips of corresponding composite material,
wherein the first composite material includes a matrix of a polymer-based material and natural fibers for a reinforcing material, and
wherein the number of openings extend through at least one layer of the one or more compressed layers of the second composite material, such that the second composite material surrounds the number of openings.
